(19) United States
(12) Patent Application Publication
(10) Pub. No.: US 2002/0084961 A1
(43) Pub. Date: Jul. 4, 2002

(54) Liquid crystal display device and a method of operating a liquid crystal display device

(76) Inventors: Elizabeth Jane Acosta, Oxford, AL (US); Michael John Towler, Oxford, AL (US)

Correspondence Address: Neil A. DuChez, Renner, Otto, Boisselle , & Sklar, L.L.P., 19th Floor, 1621 Euclid Avenue, Cleveland, OH, 44115, US

(21) Appl. No.: 09/956,488

(22) Filed: Sep. 19, 2001

(30) Foreign Application Priority Data
Sep. 23, 2000 (GB) 0023374.2

(51) Int. Cl. G09G 3/36

(52) U.S. Cl. 345/87

(57) ABSTRACT

The disclosed invention relates to a method of operating a liquid crystal display device having a layer of liquid crystal material switchable between first and second liquid crystal states, the method comprising the steps of: (a) applying a first voltage waveform across an addressable area of the liquid crystal layer of the display device to put the addressable area of the liquid crystal layer into the one of the first and second liquid crystal states having the higher energy when no electric field is applied across the liquid crystal layer; and (b) putting the addressable area of the liquid crystal layer into a desired one of the first and second liquid crystal states to obtain a desired display state. A liquid crystal display device is disclosed.

### BACKGROUND OF THE INVENTION

1. Field of the Invention

The present invention relates to a liquid crystal display device in particular to a bistable twisted nematic (BTN) liquid crystal display device.

2. Description of the Related Art

The term “twist” as used herein is defined to mean the angle in the plane of the liquid crystal cell through which the liquid crystal director rotates from one surface of the cell to the other surface.

The BTN effect is disclosed in EP-A-0 018 180, and by D. W. Berreman at al “Journal of Applied Physics” Vol 52, No. 4 p3032 (1981).

The general structure of a bistable twisted nematlc (BTN) liquid crystal display device is shown schematically in FIG. 1(a). The device consists of upper and lower substrates 11, 12 with an alignment layer 13, 14 disposed on each of the substrates. A layer 15 of cholesteric (twisted nematic) liquid crystal is disposed between the substrates. Electrodes (not shown) are provided on the upper and lower substrates 11, 12, to allow a voltage to be applied across the liquid crystal layer.

FIGS. 1(a) to 1(d) show the principle of operation of a BTN liquid crystal display device. When the rubbing direction of the upper alignment film 13 is at an angle Φ to the rubbing direction of the lower alignment film 14, a cholesteric (twisted nematic) liquid crystal material conventionally having a pitch (p) approximately equal to the cell gap (d) multiplied by 360°/Φ (if Φ is in degrees) or by 2π/Φ (if Φ is in radians) adopts an initial state having a twist angle Φ when no voltage :is applied across the liquid crystal layer 15. When the rubbing directions of the two alignment films are anti-parallel (that is, Φ=180°), the Φ twist state has the disadvantage of being splayed.

In addition to the initial stable Φ twist state, two further metastable Btates which are free from splay, but which have less favourable degrees of twist, namely Φ−180° and Φ+180° (or, in radians, Φ−π and Φ+π) can exist. These states are shown in FIGS. 1(c) and 1(d) respectively. For a BTN liquid crystal cell in which Φ=180°, the metastable states of FIGS. 1(c) and 1(d) have twist angles of 0° and 360°, respectively. Controllable switching between these two metastable twist states is used in a BTN liquid crystal display device. When the BTN liquid crystal cell of FIG. 1(a) is disposed between crossed linear polarizers, the Φ+π twist state of FIG. 1(d) appears dark, whereas the Φ−π twist state of FIG. 1(c) appears white when its optic axis is oriented at 45° to the polariser directions. Selection of the Φ twist state (i.e., selection of the 180° twist state if Φ=180°) in difficult, and the switching is therefore slow.

The metastable Φ−π and Φ+π twist states shown in FIGS. 1(c) and 1(d) are generated from the stable Φ twist state of FIG. 1(a) using the voltage pulses shown in FIGS. 1(e) and 1(f). With the liquid crystal in the Φ twist state, a reset pulse 16 is initially applied across electrodes (not shown.) disposed on the upper and lower substrates. The reset pulse 16 has an amplitude and duration sufficient to cause a transition from the Φ twist state to the homeotropic state illustrated in FIG. 1(b). In the homeotropic state, the liquid crystal molecules in the bulk of the liquid crystal layer 15 (away from the immediate vicinity of the alignment films 13, 14) are oriented perpendicular to the substrates 11, 12 as illustrated, for instance, by molecule 17.

One of two types of selective addressing pulse 18 is then applied to the electrodes to select the desired state of the device. One type of selective addressing pulse 18 causes the liquid crystal to switch from the homeotropic state of FIG. 1(b) to the metastable Φ−π twist state of FIG. 1(c). In this state, the cell appears minimally attenuating, or white, when it is disposed between orthogonal linear polarisers with the cell's rubbing direction oriented at 45° to the transmission axes of the polarisers.

The other type of addressing pulse 18′ causes the homeotropic state of FIG. 1(b) to switch to the metastable Φ+π twist state of FIG. 1(d). This is the maximally attenuating, or black, state when the liquid crystal cell is disposed between orthogonal linear polarisers.

The energies of the stable twist state and the two metastable twist states depend on the ratio between the cell gap of the liquid crystal cell and the pitch of the liquid crystal molecules. FIG. 2(a) shows the energy G_{E} of the 0°, 180°, and 360° states, for a device in which Φ=180°, at zero applied electric field as a function of the thickness-to-pitch ratio (d/p) for a surface tilt of 0° and for a surface tilt of 20°. It can be seen that, in general the three states have different energies, with the stable 180° twist state being the lowest energy state over the range of approximately 0.25<d/p<0.75. This state is normally topologically distinct from the two metastable twist states, and It does not correspond to one of the operating states of the LCD. The results of FIG. 2(a) were obtained for a particular liquid crystal material, but similar results are obtained for other liquid crystal materials.

This difference in energy between the Φ−π state, the Φ state and the Φ+π state presents two problems. Firstly, the energetically favourable stable 0 twist state is liable to nucleate and grow into the metastable Φ−π and Φ°π operating states over a period of time when no voltage is applied to the liquid crystal cell. Secondly, even if the undesired stable Φ twist state does not nucleate, since the two metastable Φ−π and Φ+π states do not have the same energy the more energetically favourable of the metastable states will slowly grow into the other one when no voltage is applied across the liquid crystal layer 15 This means that a BTN LCD will not retain a desired display when the device is switched off—a conventional BTN LCD ti not a true bistable device, and the display must be continually refreshed in order to maintain a desired image.

One particular application of BTN LCDs is in low power LCDs, such as portable LCDs. It is desirable for such devices to have as low a power consumption as possible, to increase the maximum time for which a device can be used without recharging. It is therefore undesirable to have to update the display frequently in order to prevent the nucleation and growth of undesired states, since this will increase the power consumption.

One type of LCD is a storage LCD. A storage LCD displays an image that changes only infrequently such as, for example, a display of departure information at an airport, a display in an electronic book (or “e-book”), or a display in a mobile telephone. A storage display its operated by addressing the display to display a desired image. Ideally, it would not be necessary to address the display until the display needed to be changed, but in practice it is necessary to “refresh” the display periodically in order to prevent the displayed image from degrading, for example as the result of nucleation of an undesired state in the liquid or crystal layer. In this node of operation power is consumed by the display only when it is initially addressed or when it is subsequently refreshed, so that it is desirable for the refreshing operations to be carried out as infrequently as possible.

This requires that possible causes of degradation of the display must be reduced as far as possible.

Another application of a LCD is to display the rapidly changing image, such as a video image. The operation of such a display requires that the addressing time of the display must be small, in order to allow the image to be updated at the same rate as the video data.

Two methods of confining addressed regions in a BTN liquid crystal display are disclosed in D. W. Betreran et al., “Journal of Applied Physics”, Vol. 52 No. 4 p3032 (1981). Both methods described in this document provide unaddressed regions in the LCD, to separate the addressed regions. The thickness-to-pitch ratio of the unaddressed regions of the LCD is reduced in order to stabilise the Φ twist state within the unaddressed regions. Adjacent addressed regions can be switched between the 0° and 360+ twist state, and are isolated from one another by the unaddressed regions. One method of reducing the thickness-to-pitch ratio of the unaddressed regions is to reduce the thickness of the liquid crystal layer of the unaddressed regions. The other method disclosed is to increase the tilt of the directors of the liquid crystal molecules at the interfaces between the liquid crystal layer and the alignment films in the unaddressed regions compared with in the addressed regions, to increase the effective pitch of the liquid crystal molecules.

However, isolation by reduction of the cell thickness in the unaddressed regions requires the whole of the addressable region to be surrounded by a wall, and the wall height needs to be at least ⅔ of the cell thickness to provide effective isolation. This may lead to problems in filling the device with liquid crystal material, since air will tend to become trapped at corners of the walls.

Further problems occur in obtaining the required uniformity in the thickness of the cell. If spacer balls are used these can have a diameter of ˜⅓ the cell thickness if they are placed on the walls, but in this case it is difficult to position the spacer balls. Alternatively, spacer balls having a thickness equal to the cell diameter can be used; in this case, great care is required to ensure that the spacer balls are placed in the addressable regions and are not placed on the walls. Both of these methods are difficult to carry out accurately. A further alternative is to fabricate pillars on the walls, with the combined heights of the walls and pillars being equal to the desired cell thickness. The pillars are provided by repeating the wall fabrication process, but with a different mask to provide pillars rather than walls. This requires a further process step, and also requires precision alignment of the mask for the pillars.

Providing Isolation by modifying the pre-tilt on both substrates means that high precision is required when aligning the two substrates.

Hokeket al., “SID 97 Digest”, p29 suggest that, for high speed performance of a BTN LCD the display should be refreshed of ten enough to prevent nucleation and growth of the 180° twist state. As noted above, this method is undesirable in a storage LCD since it increases the power consumption of the LCD.

EP-A-0 579 247 discloses a technique for choosing the positions of the polarisers between which liquid crystal cell is placed, in order to provide the greatest contrast in a transmissive BTN LCD. The document suggests that greatest contrast is obtained when the ratio of the thickness of the liquid crystal layer, d, to the pitch of the liquid crystal molecules, p, should satisfy the relationship 0.5Φ/2π<d/p<1.5Φ/2π. However, the need to obtain practical memory retention times and operation means that the d/p ratio cannot lie in all this range but is constrained to the range 0.8Φ/2π<d/p<1.4Φ/2π.

Hoke and Bos disclose in “SID 98 Digest”, p854 a BTN LCD in which polymer walls are formed around each pixel in order to prevent the growth of the 180° twist state. In this method, a photopolymerisable monomeric liquid crystal material is used, and this is selectively exposed to radiation using a mask while a voltage is applied to the liquid crystal cell. This method is disadvantageous since it is difficult to obtain well-defined wall structures while not reducing the area of the addressable region. Furthermore, the in-situ polymerization process can lead to ionic contamination and result in image sticking, (that is, difficulty in re-writing a pixel from one operating state to the other operating state).

One can foresee placing a physical barrier, having a height equal to the cell thickness, around individual addressed areas. This has the disadvantage, however, that it complicates the manufacture of the LCD. In particular, it becomes very difficult to fill the panel with liquid crystal material.

EP-A-0 613 116 discloses a method of driving a BTN liquid crystal display device. Initially, a reset pulse is applied across the liquid crystal layer to induce a Frederick's transition in the liquid crystal material. Next, there is a delay period in which no voltage is applied across the liquid crystal layer. A select voltage pulse is then applied across the liquid crystal layer to put the liquid crystal into one of the two metastable states. Finally, for the remainder of the frame a voltage having a voltage lower than the select voltage pulse is maintained across the liquid crystal layer to maintain the liquid crystal in one of the metastable states. This driving method is unsuitable for use in a battery-operated device, since It requires a voltage to be maintained across the liquid crystal layer virtually continuously.

EP-A-0 911 793 also discloses an addressing scheme for a BTN liquid crystal display device. As in the addressing method of EP-A-0 613 116, a reset voltage pulse is initially applied across the liquid crystal layer to induce the Freedericksz transition to a nematic liquid crystal state. There in then a delay period, in which a low amplitude alternating voltage is applied across the liquid crystal layer. A select voltage pulse is then applied across the liquid crystal layer to put the liquid crystal into one of the two metastable twist states. Finally, a low amplitude alternating voltage is applied across the liquid crystal layer for the remainder of the frame. According to this addressing scheme the device is continually up-dated and, in consequence, the low amplitude alternating voltage is applied for a long time. This gives rise to a high power consumption, so that this method also is unsuitable for use with a battery-operated device.

### SUMMARY OF THE INVENTION

A first aspect of the present invention provides a method of operating a liquid crystal display device having a layer of liquid crystal material switchable between first and second liquid crystal states, the method comprising the steps of: (a) applying a first voltage waveform across an addressable area of the liquid crystal layer of the display device to put the addressable area of the liquid crystal layer into the one of the first and second liquid crystal states having the higher energy when no electric field is applied across the liquid crystal layer; and (b) putting the addressable area of the liquid crystal layer into a desired one of the first and second liquid crystal states to obtain a desired display state.

The two operating states of a bistable twisted nematic LCD will generally have different energies. According to-the present invention, the addressable area of the liquid crystal layer is put into the operating state that has the higher energy in zero applied electric field, by applying the first voltage waveform (which acts as a blanking voltage waveform). Once the addressable area of the liquid crystal layer has been put into the higher energy one of the operating states, the addressable area of the liquid crystal layer is put into the operating state required to give the desired display state of the addressable area of the liquid crystal layer, for example by applying a further voltage waveform to the addressable area of the liquid crystal layer. This further voltage waveform is known as a select voltage waveform, since it selects the desired one of the operating states. If the desired display state of the addressable area requires that the addressable area is in the higher energy one of the operating states then the addressable area of the liquid crystal does not require to be switched, and the select voltage waveform is chosen accordingly. If, however, the desired display state of the addressable area requires that the addressable area is in the lower energy one of the operating states the select voltage waveform is required to switch the addressable area of the liquid crystal into the lower energy one of the operating states.

The liquid crystal layer of a liquid crystal display device generally comprises a plurality of independently addressable areas. When such a device is operated according to a method of the invention, all or substantially all the addressable areas of the liquid crystal layer are initially switched into the higher energy one of the operating states, by applying a blanking voltage waveform. The desired image display is then obtained by switching selected ones of the addressable areas to the other operating state.

When the invention is applied to a BTN liquid crystal display device, all or substantially all the addressable areas of the liquid crystal layer are initially switched into the higher energy one of the two metastable twist states. Blanking all, or substantially all, the. addressable areas of liquid crystal layer to the higher energy one of the metastable states, and then selecting the lower energy one of the metastable states in one or more areas increases the time during which the higher energy one of the metastable states will remain at zero applied fields. This is because blanking all, or substantially all, the addressable areas of the liquid crystal layer to the higher energy one of the metastable states removes the more energetically favourable low energy one of the metastable states from the liquid crystal layer, and regions of the low energy metastable state will not appear until the low energy metastable state is nucleated, grows in from an unswitched region of the liquid crystal layer (for example an inter-pixel gap) or is selected by a select voltage waveform.

In contrast, in a conventional addressing method in which the liquid crystal layer is not blanked to the higher energy state, then it is possible that micro domains of the lower energy state will remain within the areas of the liquid crystal layer that have nominally been switched to the higher energy state. When the applied field is removed, these micro-domains of the lower energy state will grow into the regions of the high energy state, thereby degrading the display.

A further advantage of the present invention is that, since the blanking voltage puts the liquid crystal material into the high energy one of the operating states, the select voltage waveform is required only to switch the liquid crystal material from the high energy one of the operating states into the low energy one of the operating states. This allows the select voltage waveform to be chosen to give short (<100 μs) line address times (l.a.t.s.), and this enables a display device to be updated rapidly and even to be driven at a video rate. Much longer l.a.t.s. (of the order of microseconds) would be required if the select voltage waveform had to switch the liquid crystal material from the low energy one of the operating states into the high energy one of the operating staten.

Step (b) may comprise applying a second voltage waveform across the addressable area of the liquid crystal layer to put the addressable area of the liquid crystal layer into the one of the first and second liquid crystal states having a lower energy when no electric field is applied across the liquid crystal layer. As noted above, the second voltage waveform acts as a select voltage waveform, since it selects the liquid crystal state that has the lower energy in zero applied field. The combination of applying the first voltage waveform (the blanking voltage waveform) to put the liquid crystal layer into the higher energy one of the operating states and, if desired, applying the select voltage waveform to select the lower energy one of the operating states enables the liquid crystal layer to be put into the desired operating state.

The method may further comprise the step of (c) applying a first zero voltage waveform across the addressable area of the liquid crystal layer, step (c) being carried out after step (a) and before step (b). It it possible to-apply the blanking voltage waveform to other addressable areas of the liquid crystal during the time when the first zero voltage waveform is being applied to one addressable area of the liquid crystal layer. This enables all addressable areas of the liquid crystal layer to be put into the higher energy one of the operating states before the desired operating state in selected in any of the addressable areas. Blanking all the addressable areas to the higher energy one of the operating states minimizes the likelihood that the lower energy one of the operating states is present in any of the addressable areas.

The method may further comprise the step of (d) applying a reset voltage waveform across the addressable area of the liquid crystal layer to put the addressable area of the liquid crystal layer into the first or second liquid crystal state, step (d) being carried out before step (a). As noted above, the two operating states of a bistable liquid crystal layer are not necessarily the lowest energy states of the liquid crystal. Thus, when a liquid crystal layer is initially addressed, it is possible that it will not be in one of the operating states. The reset voltage waveform is applied to ensure that the liquid crystal layer is in one of the operating states, so that the blanking voltage waveform is required only to switch the liquid crystal from the lower energy one of the operating states to the higher energy one of the operating states. This decreases the required magnitude and/or duration of the blanking voltage waveform.

The method may further comprise the step of (e) applying a second zero voltage waveform across the addressable area of the liquid crystal layer, step (e) being carried out after step (d) and before step (a). The duration of the zero-voltage waveform can be selected in order to reduce the-magnitude and or the duration of the blanking voltage waveform.

The method may comprise the steps of: in a first frame, applying the reset voltage waveform to the addressable area of the liquid crystal layer, applying the first voltage waveform to the addressable area of the liquid crystal layer, and putting the addressable area into a desired one of the first and second liquid crystal states to obtain a desired display state for the first frame; and, in a second frame, applying the first voltage waveform to the addressable area of the liquid crystal layer and putting the addressable area into a desired one of the first and second liquid crystal states to obtain a desired display state for the second frame, but not comprising the step of applying the reset voltage waveform in the second frame.

As noted above, the reset voltage waveform is applied to ensure that the liquid crystal layer is in one of the two operating states when the blanking voltage waveform is applied. When the display has been addressed in a first frame, the liquid crystal layer will be in one of the two operating states, as a consequence of applying the blanking voltage waveform and, possibly, the select voltage waveform. It is therefore possible to omit the reset voltage waveform in the second frames and this shortens the-duration of the second frame and reduces the power consumption of the display.

The method may alternatively comprise the steps of: in a first frame, applying a first reset voltage waveform to the addressable area of the liquid crystal layer, applying the first voltage waveform to the addressable area of the liquid crystal layer, and putting the addressable area into a desired one of the first and second liquid crystal states to obtain a desired display state for the first frame; and, in the second frame applying a second reset voltage waveform to the addressable area of the liquid crystal layer, applying the first voltage waveform to the addressable area of the liquid crystal layer, and putting the addressable area into a desired one of the first and second liquid crystal states to obtain desired display state for the second frame; wherein the time integral of the magnitude of the second reset voltage waveform is smaller than the time integral of the magnitude of the first reset voltage waveform. As noted above, at the conclusion of the first frame, the liquid crystal layer is in one of the two operating states of the liquid crystal. It is, however, possible that undesired states will nucleate into the liquid crystal layer, for example If an undesired liquid crystal state has remained in an inter-pixel gap. In this embodiment of the invention, therefore, a reset voltage waveform is applied in the second frame, but, since it is known that all addressable areas of the liquid crystal layer will be in an operating state, the second and any subsequent reset voltage waveforms can be made smaller than the first reset voltage waveform.

The duration of the second reset voltage waveform may be substantially equal to the duration of the first reset voltage waveform, and the magnitude of the second reset voltage waveform may be less than the magnitude of the first reset voltage waveform. Alternatively, the duration of the second reset voltage waveform may be less than the duration of the first reset voltage waveform, and the magnitude of the second reset voltage waveform may be substantially equal to the magnitude of the first reset voltage waveform. This reduces the total addressing time during the second frame.

The time integral of the magnitude of the first voltage waveform and/or the time integral of the magnitude of the second voltage waveform may be selected based on the temperature of the liquid crystal layer. The switching characteristics of a liquid crystal material may depend on the temperature of the liquid crystal layer, so that applying a constant voltage waveform will produce different switching effects at different temperatures, thereby degrading the display quality. This degradation of the display quality can be eliminated by varying the first voltage waveform and/or the second voltage waveform as the temperature of the liquid crystal layer varies in order to ensure uniform switching characteristics at different temperatures.

The method may comprise the step of reducing the time integral of the magnitude of the first voltage waveform and/or reducing the time integral of the magnitude of the second voltage waveform as the temperature, of the liquid crystal layer increases it may comprise the step of reducing the duration of the first voltage waveform and/or reducing the duration of the second voltage waveform as the temperature of the liquid crystal layer increases. Alternatively, or additionally, it may comprise the step of reducing the magnitude of the first voltage waveform and/or reducing the magnitude of the second voltage waveform as the temperature of the liquid crystal layer increases.

Step (b) may be carried out substantially immediately after step (a). This reduces the overall frame time required to address the liquid crystal, and it has also been found that it reduces the temperature dependence of the switching characteristic of the liquid crystal material.

The method may further comprise the step of, after putting the addressable area into a desired one of the first and second liquid crystal states to obtain a desired display state, applying a stabilizing voltage waveform across the addressable area of the liquid crystal layer, the stabilising voltage waveform being selected to substantially equalise the energy of the first liquid crystal state and the energy of the second liquid crystal state.

The energies of liquid crystal states are generally dependent on the electric field applied across the liquid crystal. The stabilising voltage waveform is chosen so that, when it is applied across the liquid crystal layer, the energy of the first liquid crystal state becomes substantially equal to the energy of the second liquid crystal state. This means that it is not energetically favourable for one liquid crystal state to change into the other, and this increases the stability of the display.

The method may comprise the steps of: switching a first addressable area of the liquid crystal layer using a method as defined above; switching a second addressable area of the liquid crystal layer using a method as defined above; and applying a voltage waveform across the second addressable area of the liquid crystal layer so as to substantially equalise the switching characteristics of the first addressable area and the switching characteristics of the second addressable area. When a liquid crystal layer is addressed, the switching characteristies may depend on the voltage applied to the liquid crystal layer after the select voltage waveform has been applied. In this embodiment of the invention, therefore, a further voltage waveform is applied across the second addressable area of the liquid crystal layer, after it has been switched to the desired state, in order to equalise the switching characteristics of the first and second addressable areas.

At least one of the voltage waveforms may be a d.c. balanced voltage waveform. This eliminates the risk of switching irregularities occurring as a result of ionic trapping.

The first liquid crystal state may be a twist state having a first twist angle, and the second liquid crystal state may be a twist state having a second twist angle different from the first twist angle. The second twist angle may be higher than the first twist angle. The first twist angle may be Φ−180° and the second twist angle may be Φ+180°, where Φ is the angle between the alignment direction of a first substrate of the device and the alignment direction of a second substrate of the device, the layer of liquid crystal material being disposed between the first substrate and the second substrate.

The first twist angle may be 0° and the second twist angle may be 360°.

The or each addressable area of the liquid crystal layer may be a pixel.

The liquid crystal layer may be a layer of a bistable twisted nematic liquid crystal material.

The ratio of the thickness of the liquid crystal layer to the pitch of the liquid crystal material may be selected such that one of the first and second liquid crystal states is the lowest energy state of the liquid crystal layer when no electric field is applied across the liquid crystal layer. This makes it energetically unfavourable for undesired liquid crystal states, such as the Φ twist state, to exist in the liquid crystal layer.

The ratio of the thickness of the liquid crystal layer to the pitch of the liquid crystal material may be selected such that the lowest energy state of the liquid crystal layer when no electric field is applied across the liquid crystal layer is a liquid crystal twist state having a twist angle of (Φ+180°), where Φ is the angle between the alignment direction of a first substrate of the display device and the alignment direction of a second substrate of the display device. The ratio of the thickness d of the liquid crystal layer to the pitch p of the liquid crystal material may be selected such that d/p>·(Φ+90°)/360°.

The ratio of the thickness of the liquid crystal layer to the pitch of the liquid crystal material may be selected such that the lowest energy state of the liquid crystal layer when no electric field is applied across the liquid crystal layer is a liquid crystal twist state having a twist angle of substantially 360°. The ratio of the thickness d of the liquid crystal layer to the pitch p of the liquid crystal material may be selected such that d/p>0.75.

The ratio of the thickness of the liquid crystal layer to the pitch of the liquid crystal layer may be selected such that one of the first and second liquid crystal states is the lowest energy state of the liquid crystal layer under substantially all operating conditions of the liquid crystal display device. As noted above, the energies of the liquid crystal states may vary as the electric field across the liquid crystal layer changes. The possibility of undesired states nucleating in the liquid crystal layer is therefore reduced further if the ratio of the thickness of the liquid crystal layer to the pitch of the liquid crystal material is selected such that one or other of the first and second liquid crystal operating states is the lowest energy state of the liquid crystal layer not only for zero applied voltage across the liquid crystal layer, but also under all voltages that are likely to be applied across the liquid crystal layer during operation of the display device.

The ratio of the thickness of the liquid crystal layer to the pitch of the liquid crystal material may be selected such that a liquid crystal twist state having a twist angle of (Φ+180°) is the lowest energy state of the liquid crystal layer under substantially all operating conditions of the liquid crystal display device.

The ratio of the thickness of the liquid crystal layer to the pitch of the liquid crystal material may be selected such that a liquid crystal twist state having a twist angle of 360° is the lowest energy state of the liquid crystal layer under substantially all operating conditions of the liquid crystal display device.

The ratio of the thickness of the liquid crystal layer to the pitch of the liquid crystal material may be at least 0.76.

A second aspect of the present invention provides a liquid crystal display device comprising a layer of liquid crystal material disposed between a first substrate and a second substrate, the layer of liquid crystal material being switchable between first and second liquid crystal states; wherein the ratio of the thickness of the liquid crystal layer to the pitch of the liquid crystal material is selected such that one of the first and second liquid crystal states is the lowest energy state of the liquid crystal layer when no electric field is applied across the liquid crystal layer.

The ratio of the thickness of the liquid crystal layer to the pitch of the liquid crystal material may be such that the lowest energy state of the liquid crystal layer when no electric field is applied across the liquid crystal layer is a liquid crystal twist state having a twist angle of (Φ+180°).

The ratio of the thickness d of the liquid crystal layer to the pitch p of the liquid crystal material may satisfy d/p>(Φ+90°)/360°.

The ratio of the thickness of the liquid crystal layer to the pitch of the liquid crystal material may be such that the lowest energy state of the liquid crystal layer when no electric field is applied across the liquid crystal layer is a liquid crystal twist state having a twist angle of substantially 360°.

The ratio of the thickness d of the liquid crystal layer to the pitch p of the liquid crystal material may satisfy d/p>0.75.

The ratio of the thickness of the liquid crystal layer to the pitch of the liquid crystal material may be selected such that one of the first and second liquid crystal states is the lowest energy state of the liquid crystal layer under substantially all operating conditions of the liquid crystal display device.

The ratio of the thickness of the liquid crystal layer to the pitch of the liquid crystal material may be selected such that a liquid crystal twist state having a twist angle of (Φ+180°) is the lowest energy state of the liquid crystal layer under substantially all operating conditions of the liquid crystal display device.

The ratio of the thickness of the liquid crystal layer to the pitch of the liquid crystal material may be selected such that a liquid crystal twist state having a twist angle of 360° is the lowest energy state of the liquid crystal layer under substantially all operating conditions of the liquid crystal display device.

The ratio of the thickness of the liquid crystal layer to the pitch of the liquid crystal material may be at least 0.76.

The device may comprise first and second addressable liquid crystal regions, each of the addressable liquid crystal regions being switchable between the first liquid crystal state and second liquid crystal state; and an isolation region provided between the first addressable liquid crystal region and the second addressable liquid crystal region, the isolation region comprising a region in which a third liquid crystal state is stable. Providing such an isolation region prevents the liquid crystal state in one addressable region from nucleating into the other addressable liquid crystal region. This further increases the stability of the display.

The liquid crystal layer may comprise a layer of bistable twisted nematic liquid crystal material.

The device may further comprise addressing means for applying a voltage across an addressable area of the layer of liquid crystal material, the addressing means being adapted, in a first frame, (a) to apply a reset voltage waveform to the addressable area of the liquid crystal layer, and (b) to put the addressable area into a desired one of the first and second liquid crystal states to obtain a desired display state for the first frame; and the addressing means being adapted, in a second frame, (c) to put the addressable area into a desired one of the first and second liquid crystal states to obtain a desired display state for the second frame; the addressing means being adapted not to apply a reset voltage waveform in the second frame.

Alternatively, the device may further comprise addressing means for applying a voltage across an addressable area of the layer of liquid crystal material, the addressing means being adapted, in a first frame, (a) to apply a first reset voltage waveform to the addressable area of the liquid crystal layer and (b) to put the addressable area into a desired one of the first and second liquid crystal states to obtain a desired display state for the first frame, and, in a second frame, (a) to apply a second reset voltage waveform to the addressable area of the liquid crystal layer and (d) to put the addressable area into a desired one of the first and second liquid crystal states to obtain a desired display state for the second frame; the addressing means being adapted to apply the first and second reset voltages such that the time integral of the magnitude of the second reset voltage waveform is staller than the time integral of the magnitude of the first reset voltage waveform.

A third aspect of the present invention provides a liquid crystal display device comprising: a layer of liquid crystal material switchable between first and second liquid crystal states: and addressing means for applying a voltage across an addressable area of the layer of liquid crystal material; wherein the addressing means is adapted (a) to apply a first voltage waveform across the addressable area of the liquid crystal layer of the display device to put the addressable area of the liquid crystal layer into the one or the first and second liquid crystal states having the higher energy when no electric field is applied across the liquid crystal layer; and (b) to put the addressable area of the liquid crystal layer into a desired one of the first and second liquid crystal states to obtain a desired display state.

### BRIEF DESCRIPTION OF THE DRAWINGS

Preferred embodiments of the present invention will now be described by way of illustrative example with reference to the accompanying figures in which:

FIGS. 1(a) to 1(d) illustrates the principle of a bistable twisted nematic liquid crystal display device:

FIGS. 1(e) and 1(f) illustrate conventional voltage waveforms suitable for selecting metastable operating states in a bistable twisted nematic liquid crystal display device;

FIG. 2(a) shows the variation of the energy of the 0°, 180 ° and 360° twist states for a BTN liquid crystal material as a function of the ratio d/p;

FIG. 2(b) shows the relationship between voltage and time of a select voltage waveform for addressing a BTN liquid crystal material;

FIG. 3(a) shows the schematic structure of a passively addressed liquid crystal display device;

FIG. 3(b) shows the relationship between transmissibility and applied voltage for a typical BTN liquid crystal display device;

FIGS. 4(a) and 4(b) illustrate the data voltage and select voltage applied to a liquid crystal layer according to a first embodiment of the present invention;

FIGS. 5(a) and 5(b) illustrate the data and select voltages applied to a liquid crystal layer in a second embodiment of the present invention;

FIG. 6 illustrates the results of switching a liquid crystal layer using the addressing scheme of FIGS. 5(a) and 5(b);

FIGS. 7(a) and 7(b) Illustrate the data and select voltages in an addressing method according to a third embodiment of the present invention;

FIGS. 8(a) and 8(b) illustrate the data and select voltages of an addressing method according to a fourth embodiment of the present invention:

FIGS. 9(a) to 9(d) illustrate the data and select voltages for addressing methods according to the fifth to eighth embodiments of the present invention;

FIG. 10 shows the switching characteristics of the embodiment of FIGS. 8(a) and 8(b);

FIGS. 11(a) and 11(b) show the data and select voltages according to an addressing method of a ninth embodiment of the present invention;

FIG. 11(c) shows the select voltage of an addressing method according to a tenth embodiment of the present invention;

FIGS. 12(a) and 12(b) illustrate the data and select voltages of an addressing method according to an eleventh embodiment of the present invention:

FIG. 12(c) illustrates the select voltage of an addressing method according to a twelfth embodiment of the present invention:

FIG. 13 shows the addressable range of a liquid crystal layer as a function of the d/p ratio and the angle Φ;

FIG. 14 illustrates the results of the addressing method of FIGS. 5(a) and 5(b);

FIGS. 15(a) to 15(c) show the relationship between the applied voltage and the stable state of a BTN liquid crystal layer as a function of the tilt angle for three values of the ratio d/p;

FIGS. 16(a) and 16(b) i illustrate the addressing method of the fourth embodiment of the present invention.

FIGS. 16(c) and 16(d) Illustrate the data and select voltages for an addressing method according to a thirteenth embodiment of the present invention;

FIG. 17(a) illustrates the results of an addressing method of 16(a) and 16(b);

FIG. 17(b) illustrates the results of the addressing method of FIGS. 16(c) and 16(d);

FIG. 18 illustrates results of the addressing method of FIGS. 5(a) and 5(b) at temperatures within the range 0° C. to 50° C.; and

FIG. 19 illustrates the results of an addressing method according to a further embodiment of the present invention at various temperatures within the range 0° C. to 50° C.

### DESCRIPTION OF THE PREFERRED EMBODIMENTS

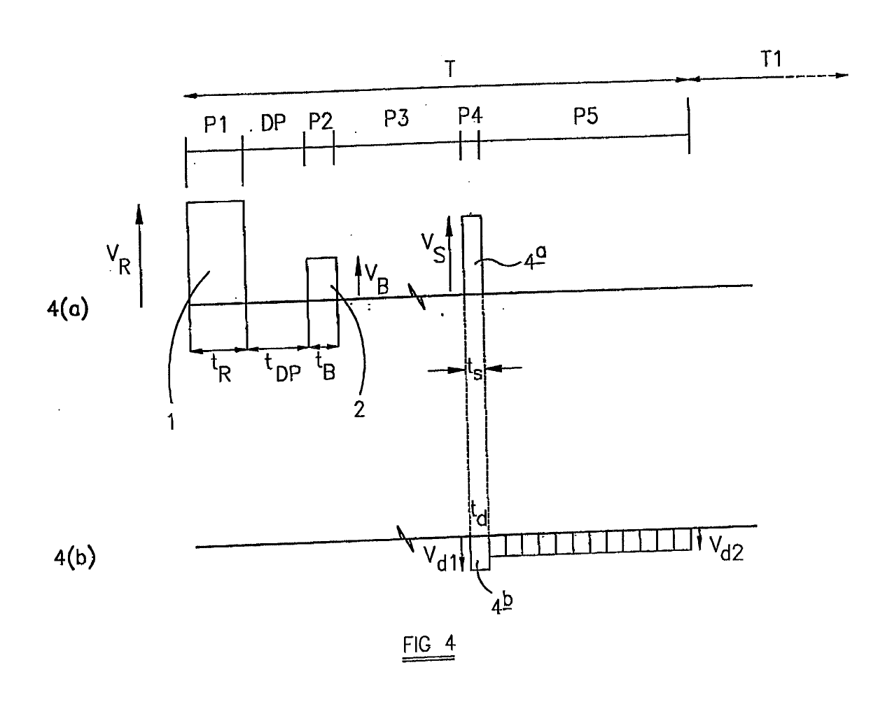

An addressing method according to a first embodiment of the present invention is illustrated in FIGS. 4(a) and 4(b). Of these FIGS. 4(a) shows the Select voltage applied to a liquid crystal layer in this embodiment, and FIG. 4(b) shows the data voltage applied to the liquid crystal layer. This embodiment relates to a passive matrix addressing scheme.

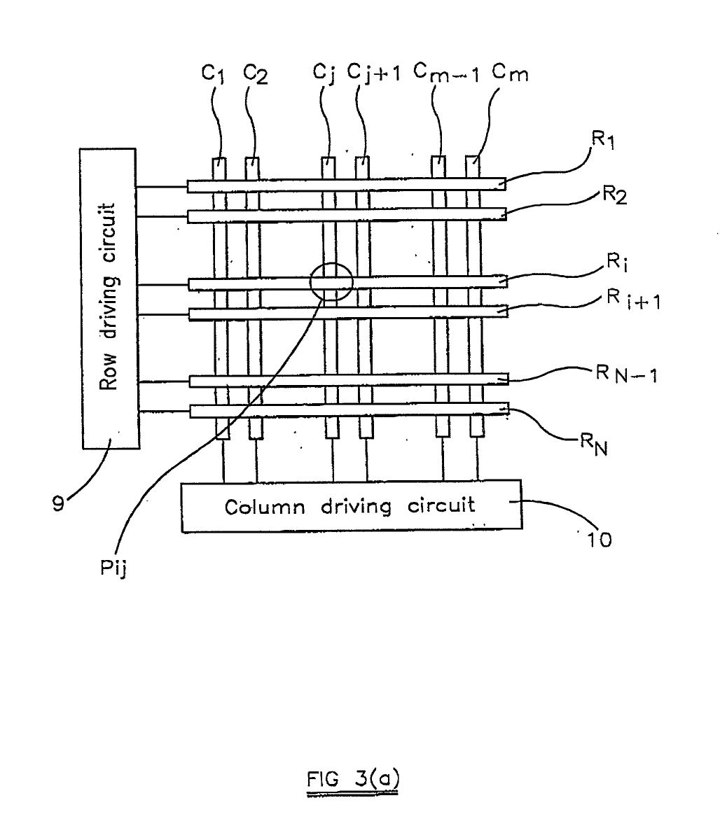

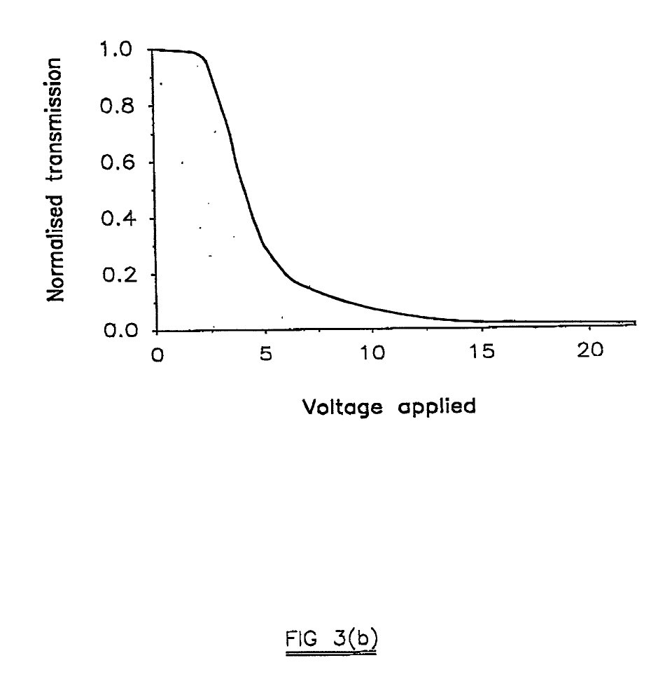

The general structure of a passively addressed liquid crystal display device is shown in FIG. 3(a). Column electrodes C₁ . . . Cⱼ . . . Cₘ are disposed on one side of the liquid crystal layer and row electrodes R₁ . . . Rᵢ . . . Rₓ are disposed on the other side of the liquid crystal layer. The row electrodes Rᵢ are crossed with the column electrodes, and are preferably at an angle of 90° to the column electrodes. A pixel Pᵢⱼ is defined at the overlap of the ith row electrode and the jth column electrode.

The display device is addressed by applying a select voltage to the first row electrode from the row driving circuit 9 while a non-select voltage, which may be zero, is applied to the other row electrodes. A data voltage is applied to the first column electrode, to address the first pixel of the first row (P₁₁). Data voltages are then applied to the remaining column electrodes in sequence, by the column driving circuit 10, to address sequentially the other pixels of the first row (P₁₂, P₁₃ . . . P_{1N}). The select voltage is then removed from the first row electrode, and a non-select voltage is applied to the first row electrode. A select voltage is then applied to the second row electrode, and data voltages are applied in sequence to the column electrode to address the pixels of the second row of the display.

The remaining rows of pixels are then selected in sequence, and the addressing process is repeated for each row of the display. The time taken to address all pixels of the display is usually referred to as a “frame”.

The voltage applied across the liquid crystal layer in a pixel is equal to the difference between the select voltage applied to the respective row electrode and the data voltage applied to the respective column electrode. The liquid crystal state, and hence the display state, of a pixel is determined by the difference between the select voltage applied to the associated row electrode and the data voltage applied to the associated column electrode. In the liquid crystal display device shown in FIG. 3(a), the row electrode R₁, the column electrode Cⱼ, the row driving circuit 9 and the column driving circuit 10 form addressing means that enable a selected area of the liquid crystal layer (namely the pixel Pᵢⱼ) to be addressed.

FIGS. 4(a) and 4(b) show the select voltage and data voltages applied to an addressable area of a liquid crystal layer, for example a pixel, over a single frame. If this embodiment of the method were used to drive a liquid crystal display device of the type shown in FIG. 3(a), the select voltage of FIG. 4(a) would be applied to one of the row electrodes by the row driving circuit 9, and the data voltage of FIG. 4(b) would be applied to one of the column electrodes by the column driving circuit 10.

Initially, a reset voltage waveform P1 is applied to the liquid crystal layer. In the embodiment of FIGS. 4(a) and 4(b) the reset voltage waveform F1 is constituted by a voltage pulse 1 in the select voltage shown in FIG. 4(a) and by a zero voltage in the data voltage shown in FIG. 4(b). The voltage pulse 1 has a, duration t_{R} and an amplitude V_{R}. The effect of the reset voltage waveform P1 is to remove the Φ twist state, and to put the liquid crystal of the pixel into one of the two metastable Φ−π or Φ+π twist states.

After the reset voltage waveform P1 has been applied, a zero voltage waveform DP is applied across the liquid crystal layer for a time t_{DP}. In the time t_{DP} the select voltage and the data voltage are both equal to zero.

A blanking voltage waveform P2 is then applied to the pixel. In the embodiment of FIGS. 4(a) and 4(b) the blanking voltage waveform P2 is constituted by a voltage pulse 2 having a duration t, and a magnitude V_{B} in the select voltage of FIG. 4(a), and by a zero voltage in the select voltage of FIG. 4(b). The duration and magnitude of the voltage pulse 2 are selected such that it puts the liquid crystal into the one of the two metastable states that has the higher energy when no voltage is applied across the liquid crystal layer. This will generally be the one of the metastable states that has the lower twist angle.

If it is desired to maintain the pixel in the high-energy metastable state to provide a desired display image, no further voltage need be applied to the pixel. If, however, it is required to put the pixel into the lower-energy metastable State to provide a desired display image, this is done by applying a select voltage waveform P4 to the pixel. In the embodiment of FIG. 4(a) the select voltage waveform P4 is constituted by a pulse 4a in the select voltage of FIG. 4(a) having a duration t_{B} and a magnitude V_{R}, and a pulse 4b in the data voltage of FIG. 4(b) having a duration t_{d} and a magnitude V_{d1}. The magnitude of the voltage applied across the liquid crystal layer will, as noted above, be given by the difference between the pulse 4a in the select voltage and the pulse 4b in the data voltage, so that the magnitude of the voltage across the liquid crystal layer will be Vₛ−V_{d1}. In the data voltage shown in FIG. 4(b) V_{d1} is negative, so that the voltage applied across the liquid crystal layer is Vₛ+|V_{d1}|. It is, however, possible for V_{d1} to be positive.

Once the select voltage waveform P4 has been applied to the pixel, no further voltages are intentionally applied to the pixel in the frame T in this embodiment. The other pixels are addressed in the remainder of the frames. The time period Ti indicates the period of time for which the panel is left under zero applied voltage (that is, in the storage mode) after the panel has been refreshed in frame T.

The addressing method of this embodiment of the invention is able to increase the time during which the low twist (high energy) operating states remains when no voltage is applied across the liquid crystal layer, by ensuring that the blanking voltage waveform fully selects the high energy state over the entire pixel. The more favourable low twist state is removed from the pixel, and will not appear in the pixel until it is nucleated, grown in from an un-switched region (such as an inter-pixel gap) or is selected by the select voltage waveform. Therefore, if no nucleation sites for the lower energy twist state exist within the pixel, the lower energy twist state will not appear until selected by the select voltage waveform or grown in from an unswitched region outside the pixel. Thus, the addressing method of this embodiment provides a longer retention time of the image then does a conventional addressing technique. This is because selecting the low twist state using conventional addressing techniques does not ensure that no microdomains of the higher twist state remain within the pixel. If any micro-domain of the higher twist state remain within the pixel, they will grow once the applied field is removed, and displace the low twist state.

The addressing technique of this embodiment, when applied to a conventional BTN LCD will reduce the refresh frequency required to retain the image on the display, thereby reducing the power consumption of the device. This is particularly valuable in the case of a storage type display device where a long memory retention time is desired in order to reduce the power consumption of the display. The present invention allows an image to be displayed at the zero applied field over a longer period of time without the display requiring refreshing.

A further advantage of the addressing method of the invention is that it is compatible with high addressing rates owing to the low l.a.t.s., and can provide a similar performance to a conventional BTN addressing technique. The present invention therefore provides a versatile addressing technique that may either provide a low refresh rate and hence a reduced power consumption when operating in a storage mode, or may produce a high refresh rate for displaying, for example, a video image.

The range of BTN reflective configurations described in co-pending UK patent application No. 9911246-8 and corresponding PCT application PCT/JP00/03118 allow a choice of which of the operating states provides the white state, and which provides the dark state. That is, it is possible to provide a display in which the low energy one of the operating states provides a white state, or provides a dark state.

In the embodiment of FIGS. 4(a) and 4(b) a 10 zero-voltage waveform DP is applied for a time t_{DP} between the end of the reset voltage waveform P1 and the start of the blanking voltage waveform P2. The duration t_{D}, of this zero-voltage waveform DP is preferably kept short, in order to minimize the overall duration T of the frame. In a preferred embodiment the zero-voltage waveform DP is entirely omitted—that is, t_{DP}=0—and the blanking voltage waveform P2 immediately follows the reset voltage waveform P1.

Alternatively, It is possible to optimise the duration t_{DP} of the zero-voltage waveform DP to improve the switching response of the liquid crystal to the blanking voltage waveform P2. In an alternative embodiment, therefore, the duration t_{DP} of the zero-voltage waveform DP is selected so as to reduce the size of the blanking voltage waveform P2—that is, in this embodiment, to reduce the magnitude and/or the duration of the pulse 2 in the select voltage.

In operation of a typical passively addressed matrix liquid crystal display device, a select voltage is applied to a row electrode, and data voltages are then applied sequentially to each column electrode of the display device, so that each pixel in the selected column is addressed. The zero voltage waveform P3 shown in FIG. 4 corresponds to the time taken to apply the reset voltage waveform P1 and the blank voltage waveform P2 to the other column electrodes of the display device. In the case of a display device having N rows, the duration of the zero voltage waveform P3 will be given approximately by (N−1)×(t_{R}+t_{DP}+t_{B}).

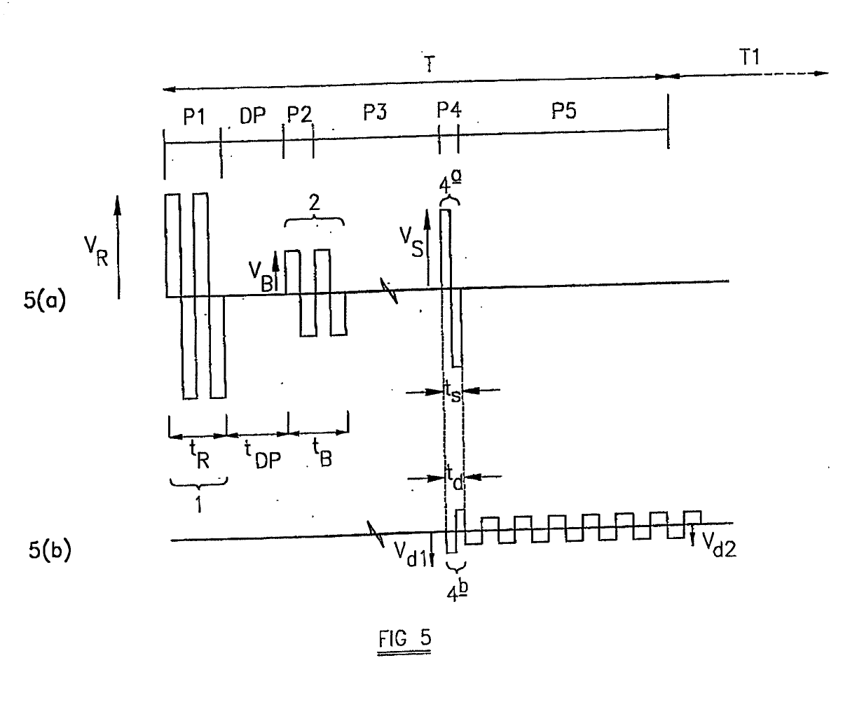

In the period P5 other pixels of the display are being addressed. The data voltage will be non-zero during this period, since a data voltage will be applied to the first column electrode to address the pixels P₂₁, P₃₁ . . . P_{N1} in the first column and in rows 2 to N of the device, and this is represented in FIG. 5 by voltage pulses having magnitude V_{d2}. However, no voltage is intentionally applied to the first row electrode in the time P5.

FIGS. 5(a) and 5(b) respectively illustrate the select voltage and the data voltage of an addressing method according to a second embodiment of the invention. The select voltage and the data voltage used in this embodiment are generally similar to the select voltage and the data voltage used in the embodiment of FIGS. 4(a) and 4(b), in that they include a reset voltage waveform P1 a blanking voltage waveform P2 and a select voltage waveform P4. In the embodiment of FIGS. 5(a) and 5(b), however, the reset voltage waveform P1, the blanking voltage waveform P2 and the select voltage waveform P4 are chosen to be bi-polar waveforms so that each voltage waveform has no net direct current (d.c.) component. In the embodiment of FIGS. 5(a) and 5(b) the voltage applied across the liquid crystal layer contains no net d.c. component, and this eliminates the risk of switching irregularities occurring as a result of ionic trapping.

In an alternative embodiment (not illustrated), the waveforms shown in FIG. 4(a) and FIG. 4(b) are used, and a net DC voltage across the liquid crystal layer is avoided by inverting the polarity of the select voltage and the data voltage every frame.

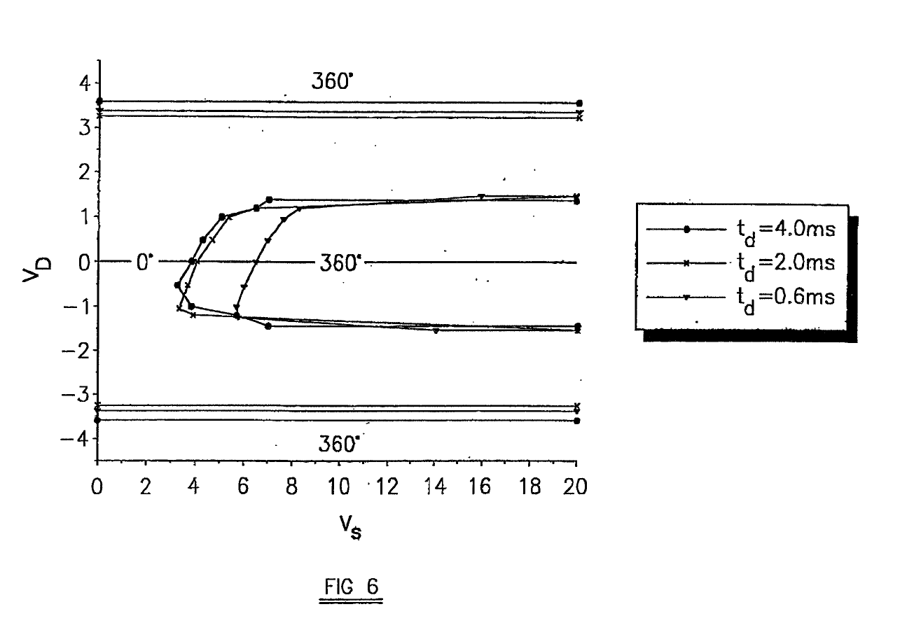

FIG. 6 illustrates the results of the addressing method shown in FIGS. 5(a) and 5(b). These results were obtained for a BTN liquid crystal display device having Φ=180°, so that the two metastable twist states are the 0° and 360° twist states. FIG. 6 shows results for durations of the select voltage waveform P4 of 0.6 ms, 2 ms and 4 ms.

The results of FIG. 6 relate to a liquid crystal cell having a liquid crystal layer with a thickness of 2 μm. The pre-tilt of the liquid crystal material is approximately 3° at both substrates, and the liquid crystal layer consists of the liquid crystal material MDA-98-86 doped with choral dopant R1011 to give a d/p ratio of approximately 0.65 (the liquid crystal and the dopant are both manufactured by Merck). The results shown in FIG. 6 were obtained at a temperature of 25°.

FIG. 6 illustrates the magnitude V_{B} of the pulse 4a in the select voltage and the magnitude V₄₁ of the pulse 4b in the data voltage that together constitute the select voltage waveform P4. The data was obtained using a reset voltage waveform P1 having a magnitude V_{R}=15V and a duration t_{R}=50 ms, a time t_{DP}=0, a blanking voltage waveform P2 having an amplitude V_{B}=2.1V and a duration t_{B}=8 ms, and a zero-voltage waveform P3 having a duration of 5000 ms. This duration of the zero-voltage waveform P3 was chosen to simulate the time it would take to blank all rows of a typical liquid crystal panel before applying the select pulse. It was found that the results of FIG. 6 were not significantly affected by choosing a shorter duration for the zero-voltage waveform P3.

It will be noted from FIG. 6 that increasing the magnitude of the select voltage waveform shortens the required duration of the select voltage waveform to switch the liquid crystal. It has been found that the duration of the select voltage waveform can be reduced to around 3 μs by using a select voltage (V_{B}−V_{d1}) of around 30V. In the example of FIG. 6 the magnitude and duration of the reset voltage waveform and the blanking voltage waveform have been selected for demonstration purposes, and have not been chosen specifically to minimise the overall switching time of the display. It would be possible to use reset and blanking voltage waveforms having shorter durations than those given above, in order to reduce the overall switching time and the frame time.

It will be seen from FIG. 6 that data voltages greater than approximately ±3V can induce switching even if the select voltage is maintained at zero. Data voltages having a magnitude of more than 3V should therefore preferably be avoided in order to prevent undesired switching of the liquid crystal. Additionally, it will be seen that data voltages greater than approximately ±1.6V can select the high energy (0°) state, so the magnitude of the data voltage should preferably be below 1.6V.

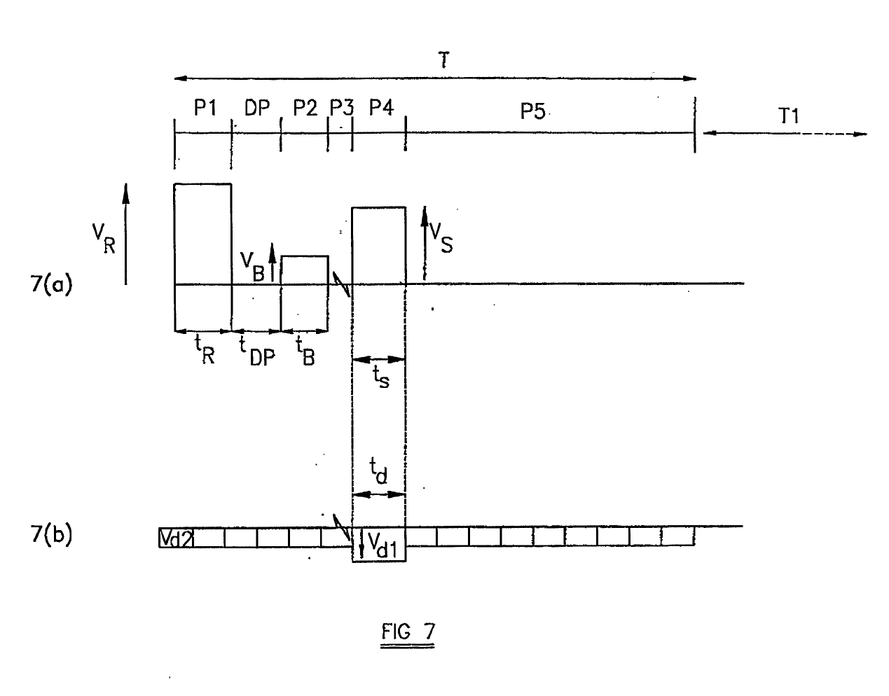

A third embodiment of the present invention is illustrated in FIGS. 7(a) and 7(b) of the application. FIG. 7(a) shows the select voltage applied to the row electrode, and FIG. 7(b) shows the data voltage applied to the column electrode.

The embodiment shown in FIG. 7(a) and 7(b) is generally similar to embodiment shown in FIGS. 4(a) and 4(b). It will be seen, however, that a data voltage is applied to the row electrode over the entire frame period T. This embodiment represent addressing a later row than the row addressed in FIGS. 4(a) and 4(b). In this embodiment the data voltage is not zero while the waveforms P1, DP, P2 and P3 are applied. The non-zero components in the data voltage before the select voltage waveform P4 is applied represent addressing earlier rows.

Any voltages applied to the liquid crystal that are not intended to switch the liquid crystal from one state to another must be maintained below a switching threshold in order to prevent them from switching the liquid crystal material. They must also be maintained below a critical voltage in order not to reduce the brightness of the display. FIG. 3(b) shows the relationship between tranamissivity and applied voltage for a typical BTN LCD. This shows the tranamissivity of the 0° twist state in an anti-parallel (Φ=180°) cell having a 2μ thick layer of liquid crystal material MDA-98-86 doped with the chiral dopant R1011 (both from Merck). The voltage—transmissibility curve shows that voltages of 1.5V or less produce no change in the transmissibility. Voltages of around 2V produce a 2% reduction in the measured transmissibility, and a 2% change is just perceivable by an observer. Thus, for this liquid crystal material, the voltage threshold for voltages that are not intended to switch the device must be maintained below approximately 2V.

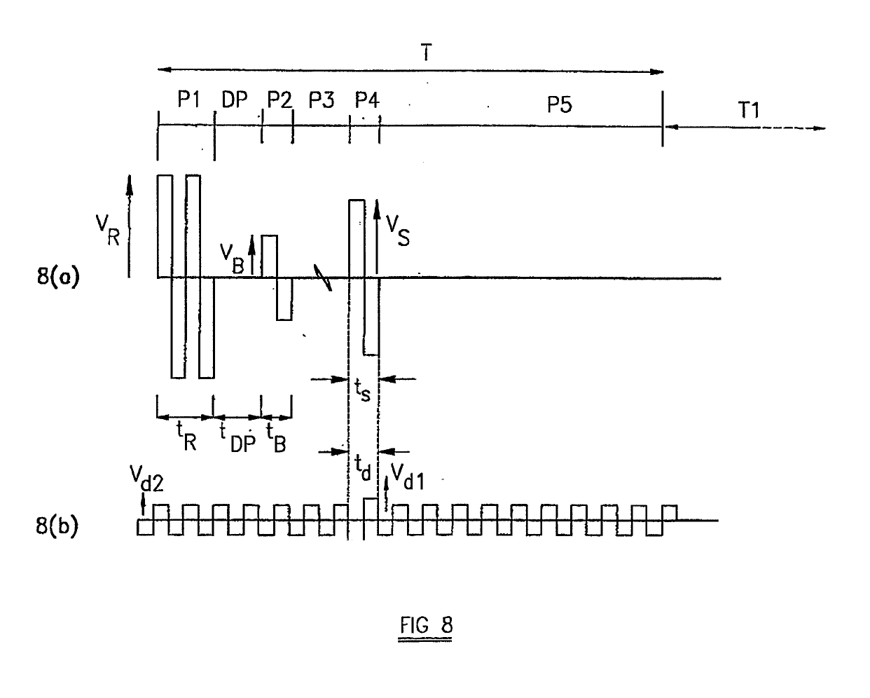

FIGS. 8(a) and 8(b) show an addressing scheme according to a fourth embodiment of the present invention. FIG. 8(a) shows the select voltage applied to the row electrode, and FIG. 8(b) shows the data voltage applied to the column-electrode. The embodiment of FIGS. 8(a) and 8(b) is generally similar to that of 7(a) and 7(b), inasmuch as a data voltage is applied to the row electrode over the entire frame period T. However, the voltage waveforms shown in FIGS. 8(a) and 8(b) each consist of bi-polar voltage waveforms, so that the select voltage waveform and the data voltage waveform each contain no net d.c. component. The advantages of this are described above with reference to the embodiment of FIGS. 5(a) and 5(b).

The select voltage and the data voltage of the third and fourth embodiments will produce similar switching characteristics to the select and data voltages of the first and second embodiments. However, the switching characteristics of the liquid crystal material to the select voltage waveform P4 will be more uniform in the third and fourth embodiments compared to the first and second embodiments. For some device such as a electronic book (“e-book”), however, the first and second embodiments may be preferable, since the first and second embodiments blank the display to give a clear screen (for example an entirely white screen or an entirely black screen) before information is displayed on the screen. Information is then displayed on the blank display.

It should be noted that the magnitude and/or duration of the reset and blanking voltage waveforms in the select voltage waveform may require slight modification, compared to the first and second embodiments, to compensate for the presence of the data voltage on the row electrode.

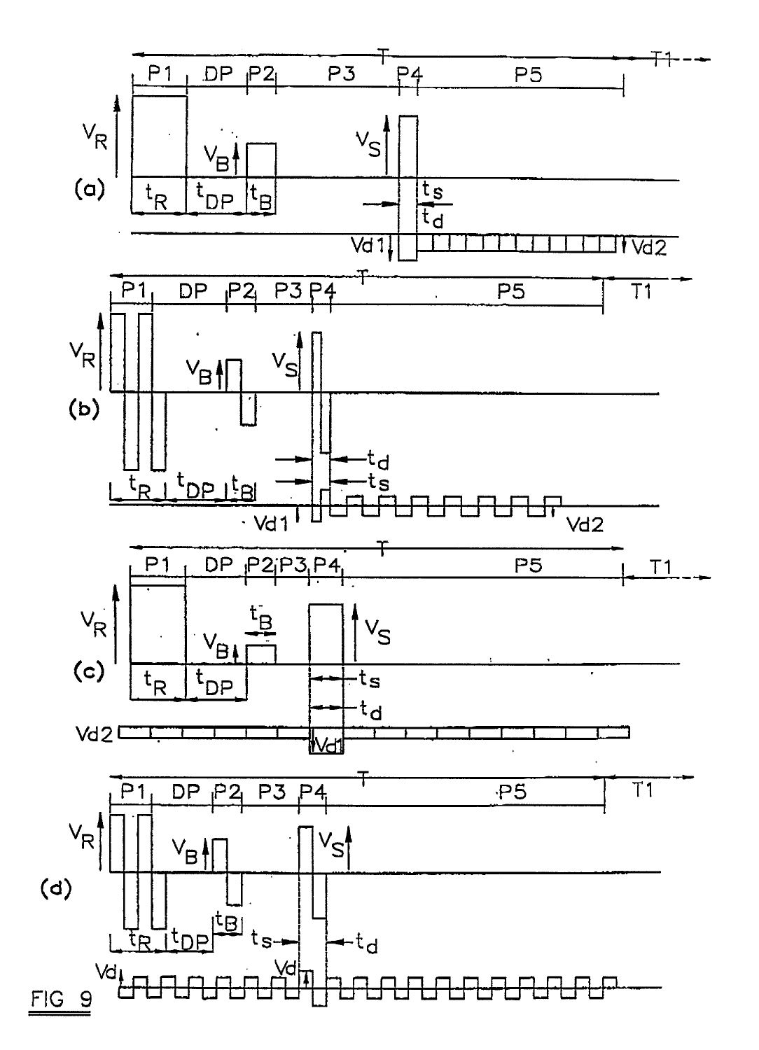

A fifth embodiment of the present invention is Illustrated in FIG. 9(a). The upper part of FIG. 9(a) shows the select voltage applied to the column electrode, and the lower part of FIG. 9(a) shows the data voltage applied to the row electrode.

The embodiment of FIG. 9(a) is generally similar to the first embodiment of the invention, except that the duration of the zero-voltage waveform P3 is much shorter than in the first embodiment. FIG. 9(a) shows a duration of a few milliseconds for the zero-voltage waveform P3 but the zero-voltage waveform of the period P3 could be reduced to zero so that the select voltage waveform P4 immediately follows the blanking voltage waveform P2. Having a short, or zero duration for the zero-voltage waveform P3 between the blanking voltage waveform and the select-voltage waveform means that the overall length of the frame period T is much shorter than in embodiments 1 to 4 described above, so that video rate Information can be displayed.

FIG. 9(b) illustrates the select voltage (upper trace) and the data voltage (lower trace) of a sixth embodiment of the invention. This embodiment generally corresponds to the fifth embodiment, in that the duration of the zero-voltage waveform P3 is short and could even be reduced to zero. The sixth embodiment differs from the fifth embodiment in that each voltage pulse in the select voltage and the data voltage is a bi-polar voltage pulse to provide d.c. balancing in each voltage waveform.

FIG. 9(c) shows the select voltage (upper trace) and the data voltage (lower trace) according to a seventh embodiment of the present invention. This generally corresponds to the embodiment of FIG. 9(a). except that a data voltage is present on the row electrode over the entire duration of the frame T.

FIG. 9(d) illustrates the select voltage (upper trace) and the data voltage (lower trace) of an eighth embodiment of the invention. This embodiment generally corresponds to the seventh embodiment shown in FIG. 9(a), except that each voltage pulse in the select voltage and the data voltage is a bi-polar voltage pulse, so that the select voltage and the data voltage waveform each have no net d.c. component.

It can therefore be seen that the fifth, sixth, seventh and eighth embodiments generally correspond to the first, second, third and fourth embodiments respectively, except that the duration of the zero-voltage waveform P3 is shorter in the fifth to eighth embodiments than in the first to fourth embodiments; the duration of the zero-voltage waveform P3 could be zero in the fifth to eighth embodiments.

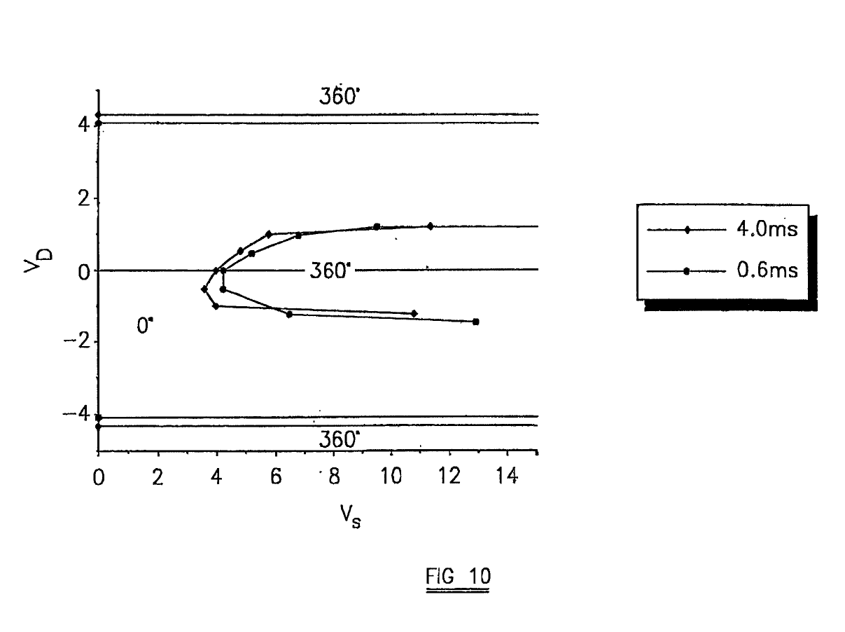

FIG. 10 illustrates the switching characteristics of the eighth embodiment of the invention. This figure shows the results of applying the select voltage and data voltage shown in FIG. 9(d) to a BTN liquid crystal layer in the 0° twist state, and observing whether the liquid crystal was switched to the 360° twist state or not. The magnitude of the pulse 4a in the select voltage and the pulse 4b in the data voltage required to switch the liquid crystal to the 360° state are shown in FIG. 10, for two values of the duration of the select voltage waveform P4. A liquid crystal cell similar to that used to obtain the results of FIG. 6 was used, although the d/p ratio of the liquid crystal cell used to obtain FIG. 10 was smaller (d/p=0.62 in FIG. 10) than for the liquid crystal call used to obtain the results of FIG. 6. The results of FIG. 10 were obtained using a select voltage in which the zero-voltage waveform DP and the zero-voltage waveform P3 both had a duration of zero. The reset voltage waveform P1 was constituted by a pulse 1 in the select voltage having a magnitude V_{R} of 20V and a duration t_{R}=40 ms. The blanking voltage waveform P2 was constituted by a pulse 2 in the select voltage having a magnitude V_{B}=3.4V and a duration of t_{B}−1.8 ms.

FIG. 10 again shows that a data voltage having a magnitude of greater than approximately 4V can induce switching of the liquid crystal even when the select voltage has a value of zero. The use of data voltages having a magnitude of more than approximately 4V is therefore preferably avoided to prevent undesired switching of the liquid crystal material. Moreover, it will be seen that data voltages greater than approximately ±1.6V can select the high energy (0° twist) state, so the magnitude of the data voltage should preferably be below 1.6V.

The first to eighth embodiments described above show select and data voltages that, when applied across a pixel generate a resultant voltage waveform across the pixel that includes a reset voltage Waveform, a blanking voltage waveform and a select voltage waveform. Of these voltage waveforms, the select voltage waveform puts the liquid crystal material of the pixel into the required one of the operating states that produces a desired display state for the pixel. The reset voltage waveform and the blanking voltage waveform are not directly related to switching the liquid crystal material into the desired one of the operating states, but are applied to ensure that the liquid crystal is in the higher energy one of the operating states before the select voltage waveform is applied. Once the display has been addressed, therefore, It is not necessary to use the entire select and data voltages of the first to eighth embodiments to update the display. Improved memory retention can be obtained by updating the display without the reset Voltage waveform, and possibly even without the blanking voltage waveform, Application of the select voltage waveform P4 at a high enough rate to maintain the display in the desired display state is all that is required to maintain the display. The elimination of the reset voltage waveform and the blanking voltage waveform will mean that the power consumption will be determined by the duration and magnitude of the select voltage waveform, and by the time interval between reapplication of the select voltage waveform. The rate of applying the select voltage waveform should therefore be kept low to reduce the power consumption, but still high enough to maintain the display in the desired state.

When a pixel is addressed using the select and data voltages of the first to eighth embodiments, the pixel is put in the desired operating state by the select voltage waveform. Until the select voltage waveform is applied the pixel may not be in the desired display state. The length of the reset voltage waveform P1, the duration of the blanking voltage waveform P2 and the durations of the zero-voltage waveforms DP and P3 are preferably kept short in order to reduce the time that the pixel may not be in the desired display state.

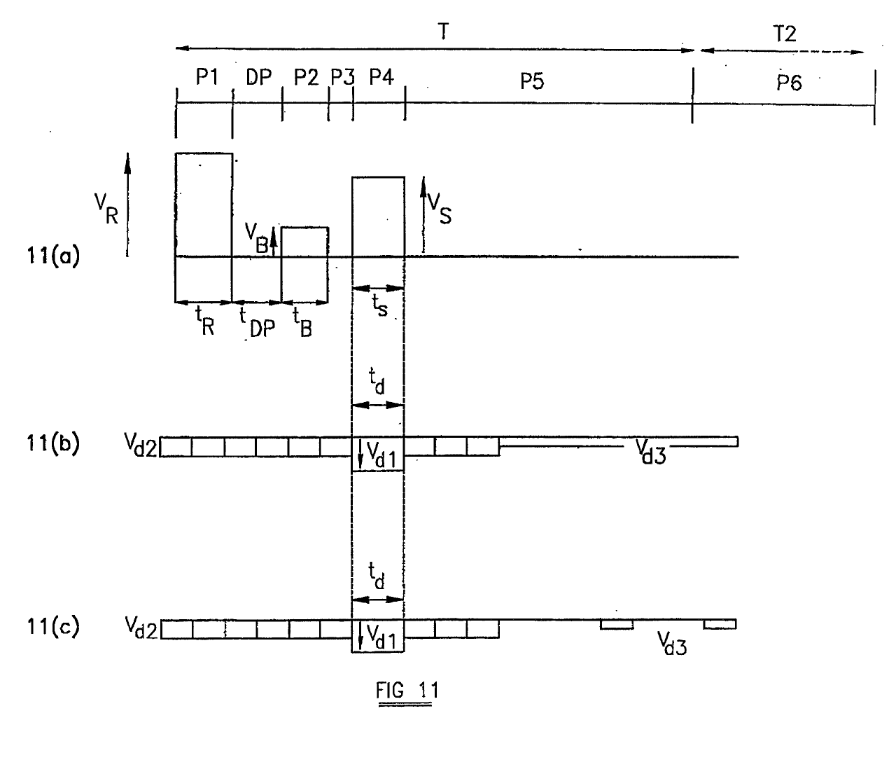

FIGS. 11(a) to 11(d) show ninth and tenth embodiments of an addressing method of the present invention. FIG. 11(a) illustrates the select voltage applied to the row electrode in both the ninth and tenth embodiments, FIG. 11(b) shows the data voltage applied to a row electrode in the ninth embodiment and FIG. 11(c) shows the data voltage applied to a row electrode in the tenth embodiment.

In the ninth and tenth embodiments of the invention, the memory retention time is increased once the device has been addressed (and the undesired stable Φ twist state eliminated) by applying a voltage close to the stability voltage V_{ST} of the two addressable states. The magnitude of the stability voltage V_{ST} is such that, when the voltage across the liquid crystal layer is substantially equal to the stability voltage, the Φ−π twist state and the Φ+π twist state have similar energies. Applying the stability voltage across the liquid crystal layer thus stabilises the two metastable states, because one metastable state is no longer energetically favoured over the other metastable state. Stabilising the two states by applying a voltage equal to, or approximately equal to, the stability voltage inhibits the propagation of one operating state into another, and avoids the need to update the liquid crystal material in a subsequent frame using the Cull waveform.

The voltage waveforms applied during a first frame in the ninth or tenth embodiment of the invention correspond generally to those applied in any of the first to eighth embodiments described above. That is to says the select voltage and the data voltage applied respectively to the row electrode and column electrode co-operate to produce an overall voltage across the liquid crystal layer that comprises a reset voltage waveform P1, a blanking voltage waveform P2 and a select voltage waveform P4. In the subsequent frame T2, however, the reset voltage waveform, blanking voltage waveform and select voltage waveform are not applied in the ninth or tenth embodiment of the invention. Instead, a voltage close to or equal to the stability voltage V_{ST} is applied across the liquid crystal layer during the second frame. The required stability voltage will vary with the thickness of the liquid crystal layer, the d/p ratio, and the pre-tilt, but is usually less than 2V. Voltages having this magnitude do not detrimentally affect the brightness of the display, as can be seen from FIG. 3(b).

In the ninth and tenth embodiments the stability voltage V_{ST} is applied arose the liquid crystal layer by applying a voltage V_{D3} to the row electrode (V_{D3}=Vₛₜ). In the ninth embodiment of the invention the stability voltage is applied continuously through the second frame T2; alternatively, the voltage V13 can be applied intermittently through the frame T2 as in the tenth embodiment of the invention illustrated in FIG. 11(c).

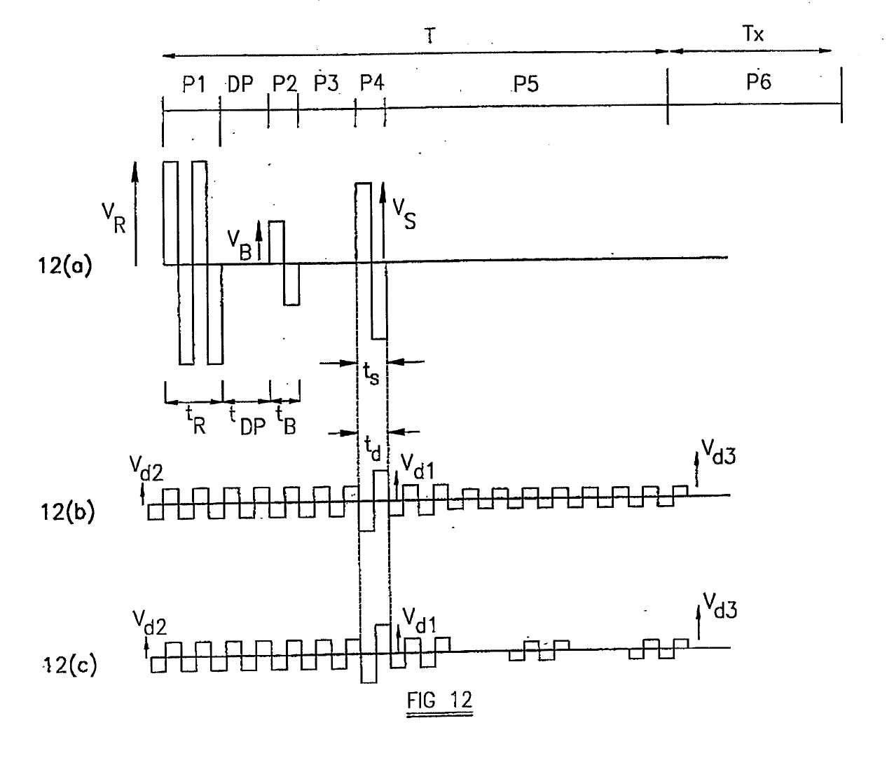

Eleventh and twelfth embodiments of the invention are illustrated in FIGS. 12(a) to 12(c). FIG. 12(a) shows the select voltage of the eleventh and twelfth embodiments, FIG. 12(b) shows the data voltage of the eleventh embodiment, and FIG. 12(c) shows the data voltage of the twelfth embodiment.

The eleventh and twelfth embodiments generally correspond to the ninth and tenth embodiments respectively, in that a voltage V_{D3} equal or approximately equal to the stability voltage V_{ST} is applied to the liquid crystal layer in the second frame TX. The eleventh and twelfth embodiments differ from the ninth and tenth embodiments in that each voltage pulse of the select voltage and the data voltage in the eleventh and twelfth embodiments is a bipolar voltage waveform and so has no net d.c. component.

In the ninth to twelfth embodiments the stability voltage is provided by applying the voltage V_{D3} to the column electrodes the voltage V_{D3} could, however, be included in the select voltage waveform and applied to the row electrodes.

In the ninth to twelfth embodiments, the length of the reset voltage waveform P1, the blanking voltage waveform P3; and the duration of the zero-voltage waveforms DP and P3 are each preferably kept short, in order to reduce the time that the display is not in the desired state.

In the embodiments described above, a reset voltage waveform is initially applied to the liquid crystal layer to eliminate the undesired stable Φ twist state. It is, however, undesirable to have to apply a reset voltage waveform because this increases the time taken to address the liquid crystal material. Moreover, a large voltage reset voltage waveform is normally required, and this increases the power consumption of the device. It would be possible to reduce the magnitude of the reset pulse needed to eliminate the undesired stable Φ twist state by spreading the reset pulse over several frames, by having a number of “dummy frames” when the device is initially switched on. However, it is preferable to eliminate the need to apply a reset voltage waveform.

One way of eliminating the reset voltage waveform is to construct the liquid crystal display such that the undesired, splayed Φ twist state is not the stable state at zero applied field. If this is done, then the need for the reset voltage waveform is reduced or eliminated.

According to a further aspect of the invention, this is done by selecting the thickness-to-pitch ratio, d/p, of the liquid crystal layer such that one of the operating states of the device is the lowest energy state at zero applied field.

In a BTN liquid crystal display device, increasing the thickness-to-pitch ratio, d/p. beyond a given value will make the high twist states (the Φ+π twist state) the lowest energy state in the absence of an applied field. This generally occurs when the thickness-to-pitch ratio is increased such that d/p>(Φ+90 )/360; for a BTN having φ180°, this requires that d/p>0.75.

There is an upper limit to the d/p ratio at which it is possible to address the low twist state (the Φ−π state), and consequently it is necessary to ensure that the d/p ratio allows both the low twist and high twist states to be addressed. The range of d/p ratios that can be addressed depends on the pre-tilt angle θ_{P} of the liquid crystal molecules adjacent the substrates of the device, the orientation direction of the liquid crystal molecules adjacent the substrates of the device, and the properties of the liquid crystal material used.

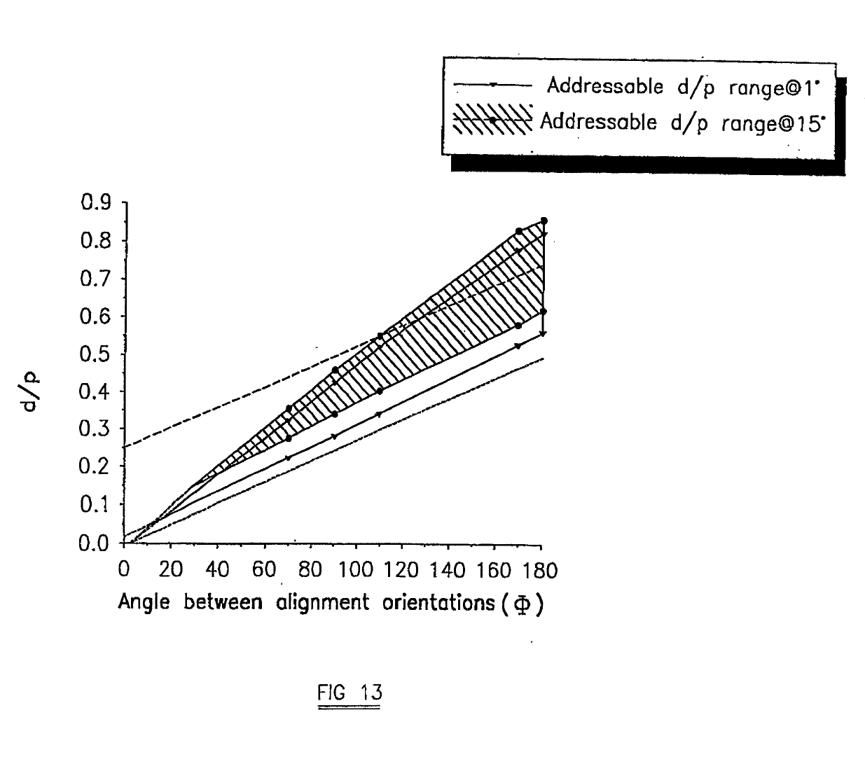

FIG. 13 shows the addressable range of d/p ratios as a function of the angle Φ between the orientation directions adjacent the two substrates of the liquid crystal device. The results of FIG. 13 were modeled using the liquid crystal material MJ 96538 produced by Merck Limited, and were obtained at a temperature at 25°. The results are shown for pre-tilt angles of θ_{P}=1° and θ_{P}=15°.

FIG. 13 shows that an anti-parallel (Φ=180°) BTN liquid crystal display device using the liquid crystal MJ96538 can be addressed up to a d/p ratio of 0.84 for a pre-tilt θ_{P}=1°, while at θ_{P}=15° it can be addressed up to d/p=0.87. Thus, it is possible to use a high d/p ratio to stabilise the high twist (Φ+π) state in zero applied field while still being able to address both operating states. The use of a high d/p ratio means that, as noted above, the splayed Φ twist state is no longer the lowest energy state in the absence on an applied electric field across the liquid crystal layer, so that the need for a reset voltage waveform to eliminate the Φ twist state is avoided. A reset voltage may still be required, however, in order to eliminate any pinned disinclinations to ensure full clean switching of the display.

FIG. 13 indicates that below a twist angle 4 of approximately 110° it is not possible to use a high d/p value to stabilise the high twist state, while still being able to address both operating states.

The region between the dashed line and the dotted line in FIG. 13 corresponds to the region in which the Φ twist state is the lowest energy state when no voltage is applied across the liquid crystal layer. Above the dashed line the Φ+180° twist state is the lowest energy state when no voltage is applied, and below the dotted line the Φ−180° twist state is the lowest energy state when no voltage is applied.

Select voltages and data voltages of the type described in the first to twelfth embodiments described above can be used to address a BTN liquid crystal display device having a high d/p ratio. The reset voltage waveform Will be significantly reduced in both magnitude and duration compared to the case when the waveforms are used to address a BTN liquid crystal display device having a low d/p ratio. For example, whereas a typical reset voltage waveform in an addressing scheme of the first embodiment would have a magnitude of 15V and a duration of 64 ms when addressing a device having a low d/p ratio, a reset voltage waveform of 8V having a duration of 18 ms would be sufficient to eliminate the undesired stable Φ twist state from a BTN liquid crystal display device having a high d/p ratio. The exact shape of the reset voltage waveform can be optimized, to produce a shorter voltage waveform (if the total addressing time la important) or to reduce the voltage of the voltage waveform.

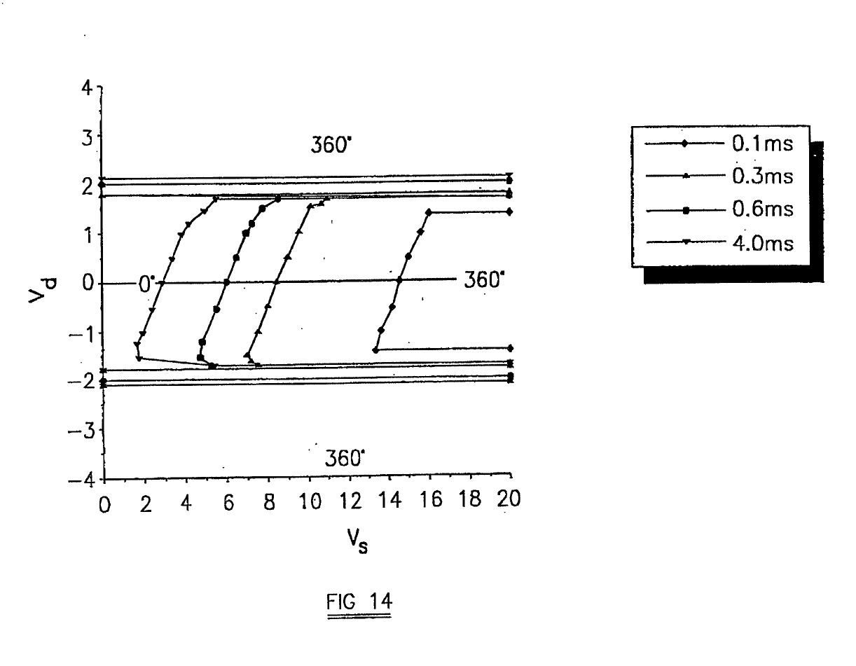

FIG. 14 shows the results of addressing a BTN LCD having a d/p ratio of approximately 0.75 using a voltage waveform according to the second embodiment of the invention described with reference to FIGS. 5(a) and 5(b) above. The results shown in FIG. 14 relate to a BTN liquid crystal display device having a liquid crystal layer with a thickness of 2 μm for the liquid crystal material MDA-98-86. The d/p ratio is approximately 0/75, and the pre-tilt angle θ_{P}=3°. The overall voltage applied across the liquid crystal layer had a reset voltage waveform of magnitude V_{R}=16V and a duration t_{R}=40 ms, which was a larger reset voltage waveform than required. The duration of the zero-voltage waveform DP was set to zero, the blanking voltage waveform had a magnitude V_{V}=2.1V and a duration t_{B}=40 ms, and the duration of the zero-voltage waveform P3 was one second. FIG. 14 shows the results for select voltage waveforms having durations tₛ of 0.1 ms, 0.3 ms, 0.6 ms and 4 ms. The results of FIG. 14 show that the duration of the select voltage waveform can be reduced by increasing the magnitude of the select voltage waveform.

In principle, it is possible to eliminate the reset voltage waveform entirely by using a sufficiently large d/p ratio to ensure that the Φ twist state is not the lowest energy state in zero applied field. In practice, however, switching the liquid crystal material may generate distillations and, if a substantial number of disseminations are generated on switching it may be necessary to apply a small reset voltage waveform to remove the disseminations. If disinclinations are generated, but a reset voltage waveform is not applied, the application of the blanking voltage waveform may not switch the entire liquid crystal material to the high energy one of the operating states.

FIG. 14 indicates that data voltages having a magnitude of more than approximately 2V can induce switching even If the select voltage is zero. Data voltages are therefore preferably kept below 2V in order to prevent undesired switching of the liquid crystal material.

Choosing a high value of the d/p ratio for the ABN LCD will ensure that the undesired, splayed Φ twist state is not the lowest energy state when no voltage in applied across the liquid crystal layer. However, the possibility remains that the Φ twist state could be the lowest energy state when the magnitude of the voltage applied across the liquid crystal layer reaches a certain level. In this case, if the Φ twist state should be nucleated while a voltage was applied across the liquid crystal layer the Φ twist state could then grow into the liquid crystal layer. In this case, a high-voltage reset voltage waveform P1 would again be required to remove the unwanted Φ twist state.

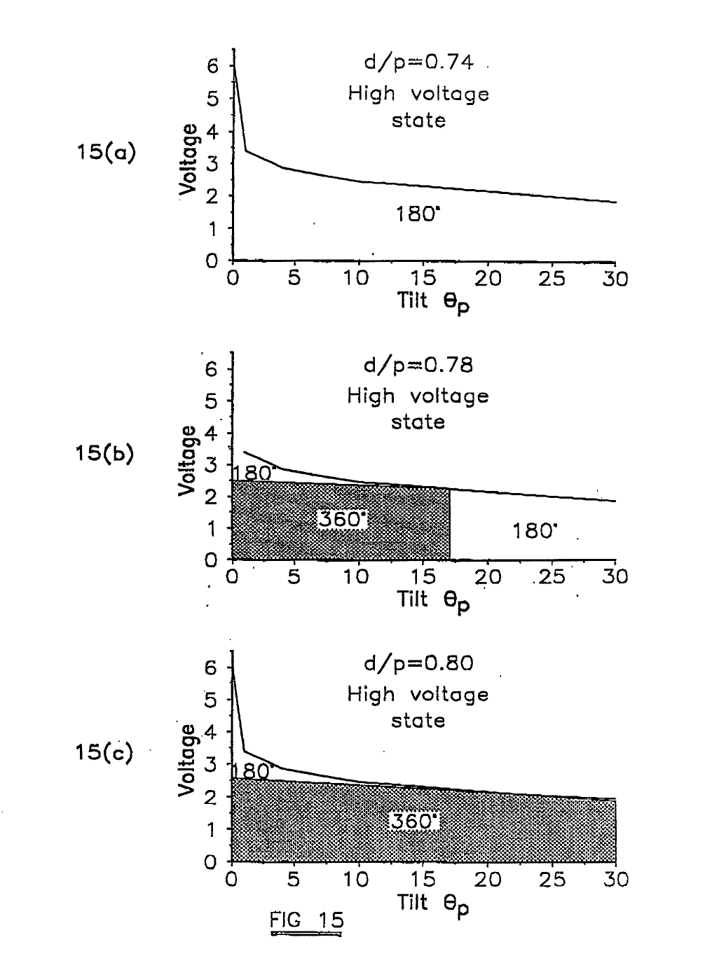

FIGS. 15(a) to 15(c) show results of modeling the energies of the states of a BTN liquid crystal cell as a function of the applied voltage and of the pre-tilt angle θp. The results indicate the lowest energy state for three values of the thickness-to-pitch ratio, namely d/p=0.74 in FIG. 15(a), d/p=0.78 in FIG. 15(b) and d/p=0.8 in FIG. 15(a). The results were modelled for a liquid crystal layer having a thickness of 2 μm of the liquid crystal MJ96538. The results were modelled for an anti-parallel BTN liquid crystal cell, so that Φ=180°. Other liquid crystal materials would give results that are generally similar in principle to FIGS. 15(a) to 15(c)—that is, that changing the d/p ratio will change the lowest energy state of the liquid crystal.

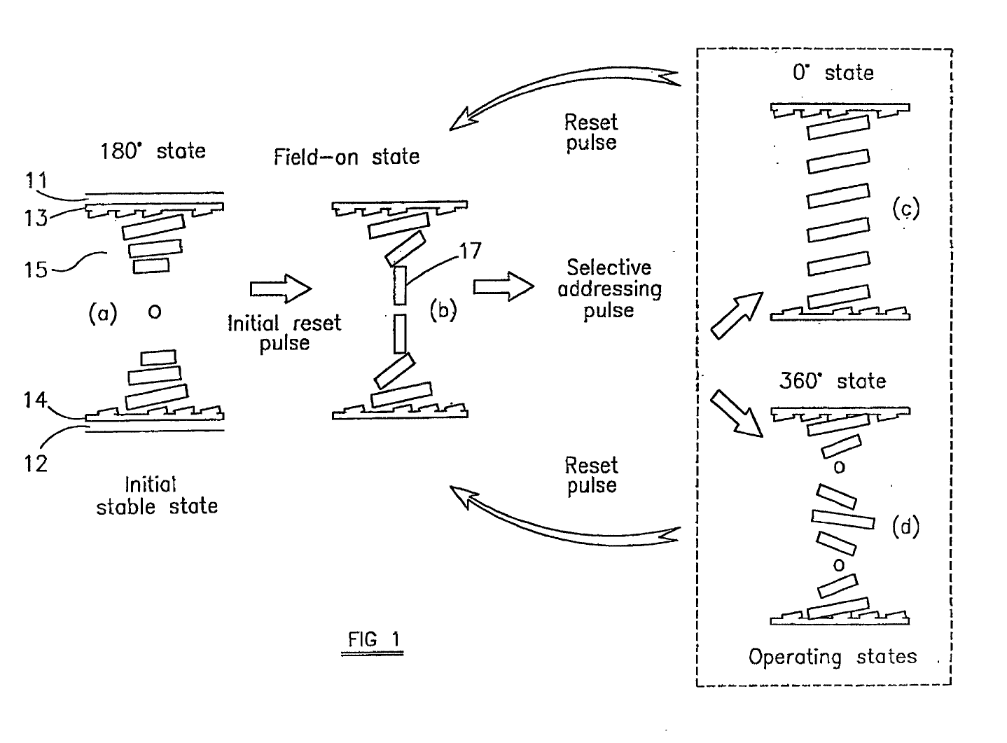

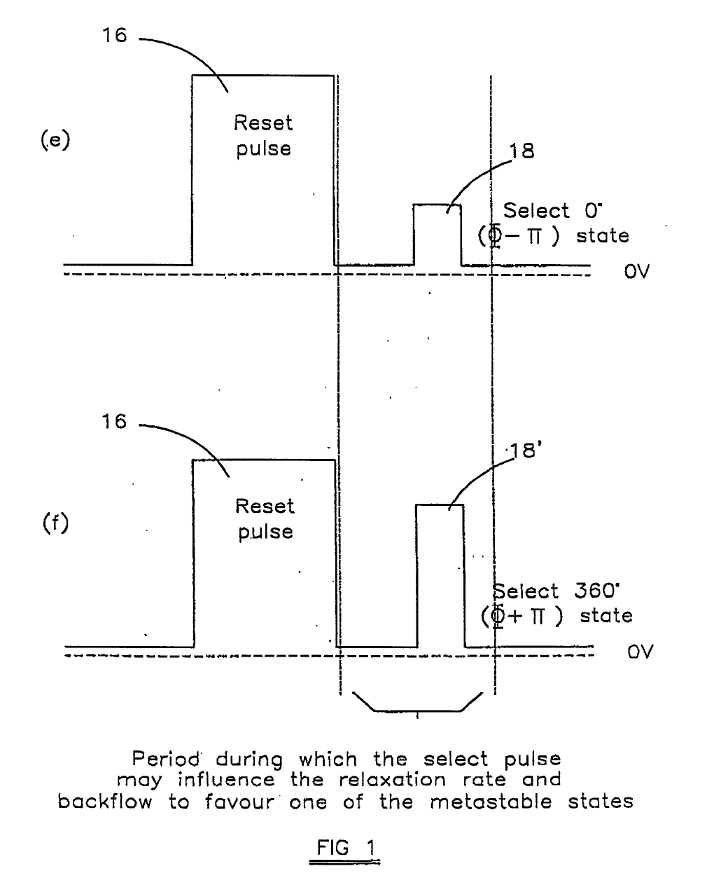

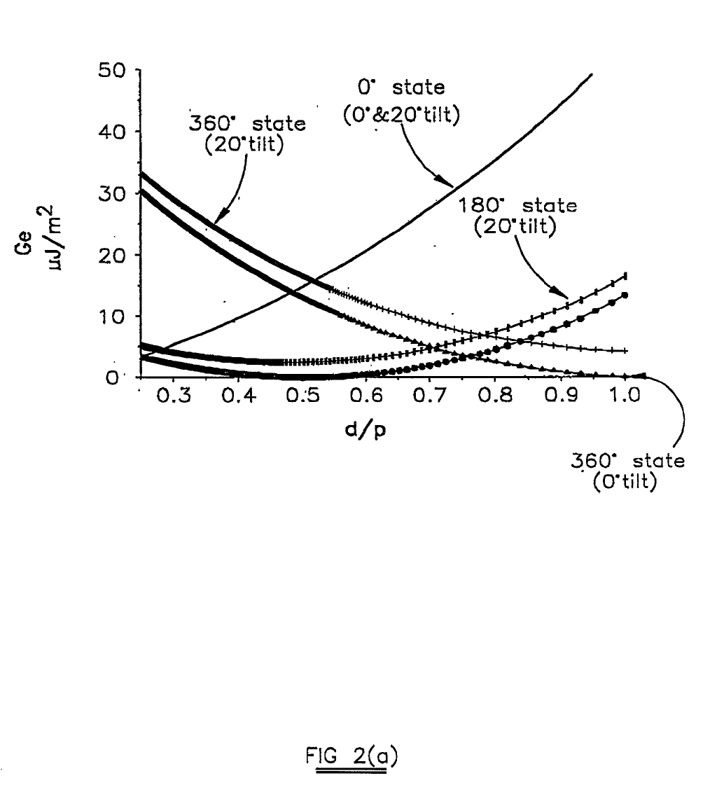

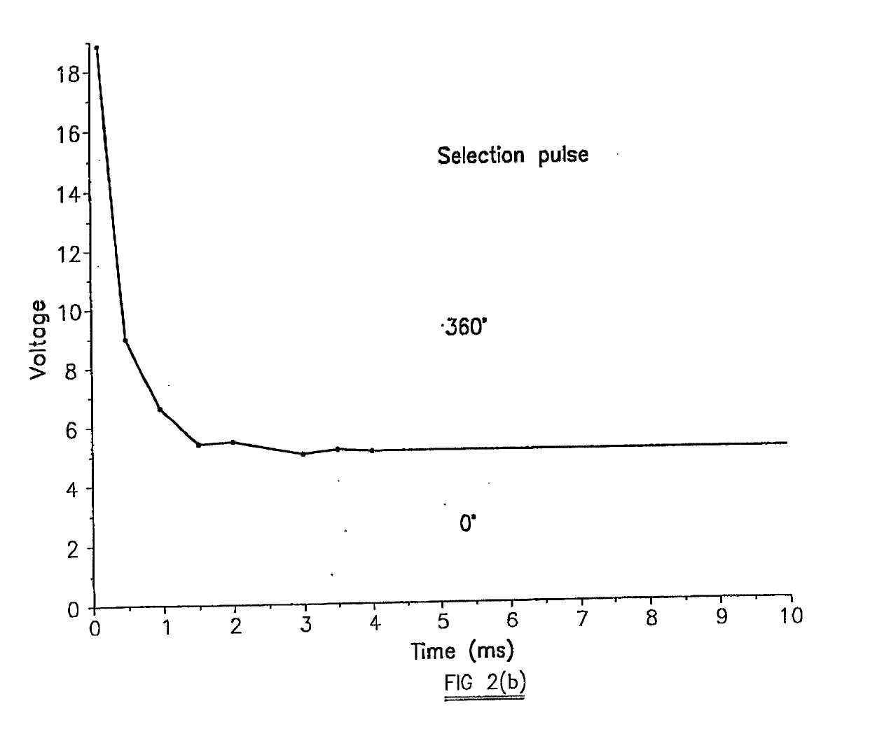

FIG. 15(a) shows that d/p=0.74, the 180° twist state is the stable state at all modelled values of the pre-tilt angle θ_{P} at low voltages. As the voltage is increased to around 2V or 3V for a pre tilt angle >1°, the high voltage, homeotropic state shown in FIG. 1(b) becomes the stable state.

FIGS. 15(b) and 15(c) show, however, that at higher values of the d/p ratio the 360° stable state becomes the lowest energy state over a wide range of pre-tilt angles and voltage. At d/p=0.78 the 360° state is the stable state for pre-tilt angles θp less than approximately 15°, and for voltages up to approximately 2.5V. As the d/p ratio. Is increased above 0.78, the range of pre-tilt angles for which the 360° twist state is the stable state increases, as shown in FIG. 15(c). Thus, FIGS. 15(b) and 15(c) show that it is possible to ensure that the lowest energy state of the liquid crystal layer is always one of the (Φ−π) and (Φ+π) twist states, for all normal operating conditions of the liquid crystal layer, by suitably selecting the d/p ratio of the liquid crystal layer. In the example of FIGS. 15(a) to 15(c), this can be done by selecting d/p>0.75.

Operating the liquid crystal display device within the voltage range for which the 360° state is always the stable state would improve the retention characteristics of the display device. Even if the 180° twist state were to nucleate, it would not be the lowest energy state, and so would not grow into the liquid crystal layer. Thus, a high-voltage reset voltage waveform will not be required.

It should be noted that the d/p range suggested as preferable by FIGS. 15(b) and 15(c) is higher than that taught or suggested in EP-A-0 579 247. This teaches that, for Φ=180°, d/p should be less than 0.75 and should preferably be less than 0.70. These values of d/p are not sufficient to ensure that the lowest energy state of the liquid crystal layer is always one of the (Φ−π) and (Φ+π) twist states.

When a liquid crystal material is switched using voltage waveforms such as those described in embodiments 1 to 12 above, the switching of the liquid crystal material in response to the select voltage waveform will be influenced by the data voltage waveform. In a display that is constantly updated, a data voltage will always be present, and all pixels of the display will be switched under the same conditions. However, in the addressing of a storage display, for which there is a time delay between each addressing operation, there is a period of time in which there is no applied field across the liquid crystal layer. That is, the pixels of the device are not continually updated, but the display is refreshed from time to time. This means that the data voltage waveform goes to zero immediately after the last pixel, or the last row of pixels, of a display have been addressed. This removal of the data voltage waveform will result in the last few pixels of the display showing different switching characteristics to the remainder of the pixels.

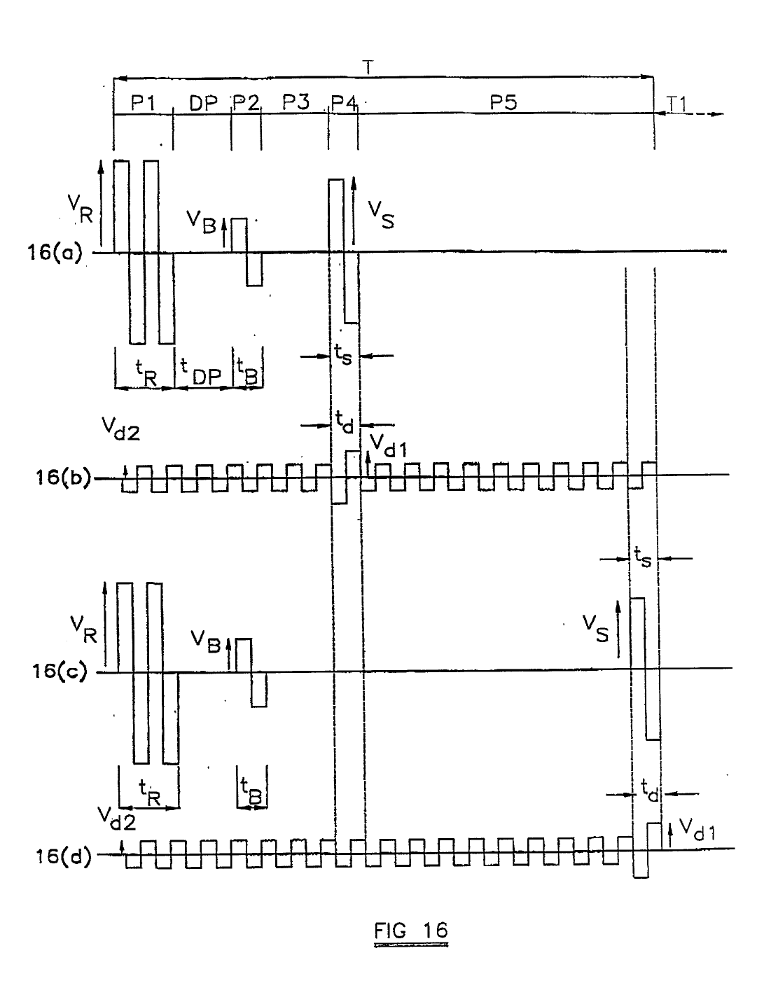

This problem is illustrated with regards to FIGS. 16(a) to 16(d). These figures relate to addressing a display using waveforms of the fourth embodiment.

FIGS. 16(a) and 16(b) show the select voltage and the data voltage for one of the first pixels to be addressed. When this pixel is addressed, the select voltage waveform P4 in a applied at a relatively early point in the frame T. Once the select voltage waveform P4 has been applied, it is followed by a period in which the select voltage is zero and the data voltage consists of voltage pulses having a magnitude V_{d2}.

FIGS. 16(c) and 16(d) illustrate switching the last pixel of the display to be switched. For this pixel, the select voltage waveform P4 is applied at the very end of the frame T. Once all pixels have been addressed there is a period T1 in which the liquid crystal display is not addressed. Thus, immediately after the select voltage waveform P4 has been applied to the last pixel of the display, the data voltage goes to zero, as does the select voltage.

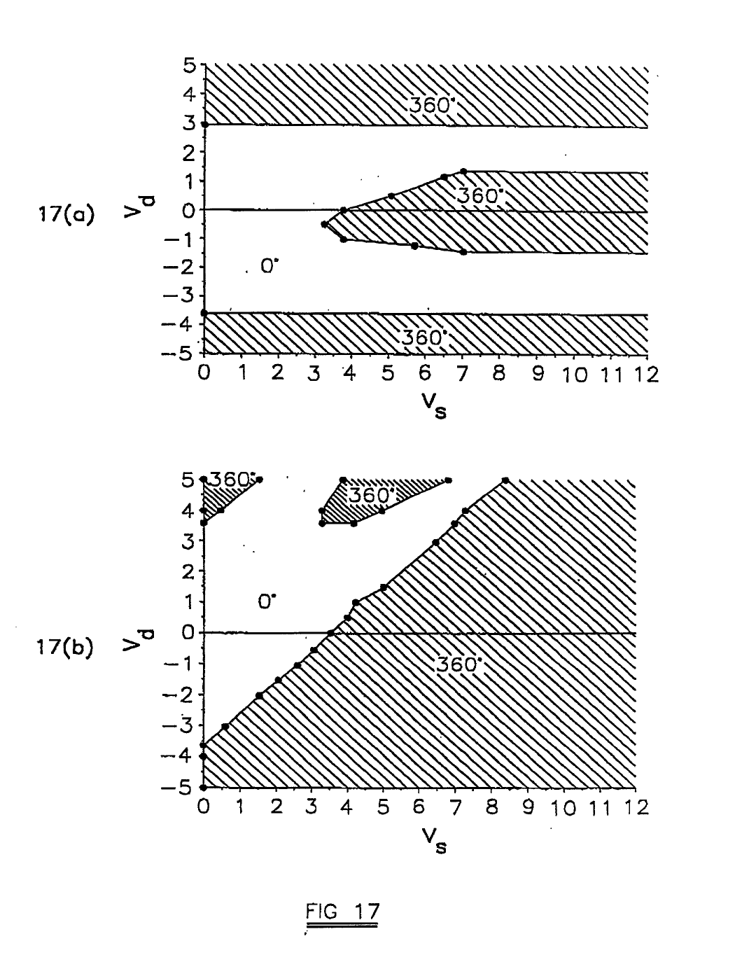

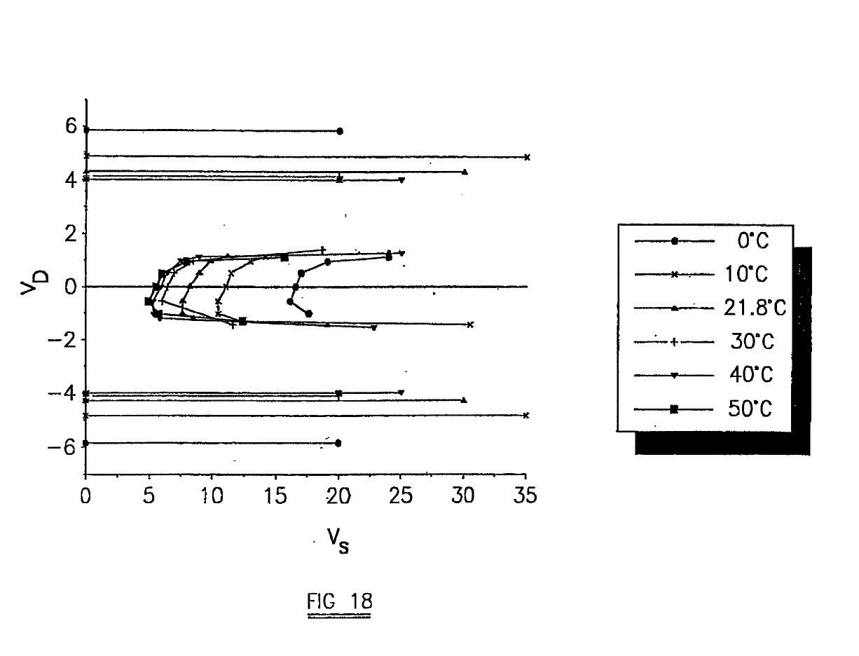

FIG. 17 shows experimental results of applying the select voltage and data voltage of FIGS. 16(a)-(d) in the case where V_{d1}=V_{d2}. FIG. 17(a) shows the results of addressing the first pixel of the display using the select voltage and data voltage of FIG. 16(a) and 16(d), and FIG. 17(b) shows the results of addressing the last pixel of the display using the select voltage and data voltage of FIG. 16(c) and 16(d). It will be seen that the switching characteristics of FIG. 17(a) are very different from those of FIG. 17(b). Removing the data voltage immediately after addressing the last pixels of a display results in the last few addressed pixels showing a quite different switching characteristic to the other pixels of the display. This difference in switching characteristics is undesirable, and may degrade the quality of the display.

The problem of the last few pixels of a display to be addressed having different switching characteristics can be overcome by maintaining the data voltage at a non-zero level for a short period after the last pixel of the display has been addressed. Applying such a “dummy data signal” for a short time, for example for 10 times the duration of the select voltage waveform, after the last pixel has been addressed will make the switching characteristics of the last few pixels to be addressed the same as the switching characteristics of other pixels.

Care should also be taken to ensure that the removal of the data voltage is not capable of inducing switching of the liquid crystal material even if the select voltage is zero. As noted above, this requires keeping the magnitude of the data voltage sufficiently low to make it incapable of inducing switching of the liquid crystal material in the absence of a select voltage.

A further problem in addressing a liquid crystal display is that changes in temperature can alter the addressing characteristics of the display, so that the use of a select voltage waveform having a fixed width and magnitude no longer selects the desired liquid crystal state. This problem is illustrated in FIG. 18.

FIG. 18 shows the results of switching a liquid crystal material using voltage waveforms according to the second embodiment of the invention. FIG. 18 shows the switching characteristics for six temperatures in the range from 0° C. to 50° C. It can be seen that as the temperature of the liquid crystal layer is reduced, a larger pulse in the select voltage is required, for a constant data voltage. to, produce switching from the 0° twist state to the 360° twist state.

In a preferred embodiment of the invention (not illustrated), therefore, the magnitude of the select voltage waveform is varied as the temperature of the liquid crystal layer varies, to compensate for this temperature-induced shift in the switching characteristics. As the temperature increases, the magnitude of the select voltage waveform is reduced, thereby reducing the time-integral of the select voltage waveform, to compensate for the change in temperature.

In another embodiment of the invention (also not illustrated), the temperature dependence of the switching characteristics is compensated for by varying the width of the select voltage waveform while keeping the magnitude of the select voltage waveform constant. As the temperature of the liquid crystal layer increases, the width of the select voltage waveform is reduced to compensate.

It is also possible to vary both the magnitude and the duration of the select voltage waveform to compensate for changes in temperature of the liquid crystal material.

In a further embodiment, the magnitude of the time integral of the blank voltage waveform is varied to compensate for variations in temperature of the liquid crystal layer. In this embodiment, the magnitude and/or the duration of the blank pulse is/are reduced as the temperature of the liquid crystal layer increases.

It is also possible to vary both the time integral of the blank voltage waveform and the time integral of the select voltage waveform to compensate for variations in the temperature of the liquid crystal layer.

Although the effects of temperature dependence on the switching characteristics can be compensated by varying the select voltage waveform and/or the blank voltage waveform, as described above, it would be preferable if the switching technique were made less sensitive to changes in temperature of the liquid crystal layer. T has been found that use of waveforms of the type shown in fifth to eighth embodiments show a lower temperature sensitivity than the voltage waveforms of the first to fourth embodiments. This temperature sensitivity does not depend of the d/p value of the liquid crystal layer.

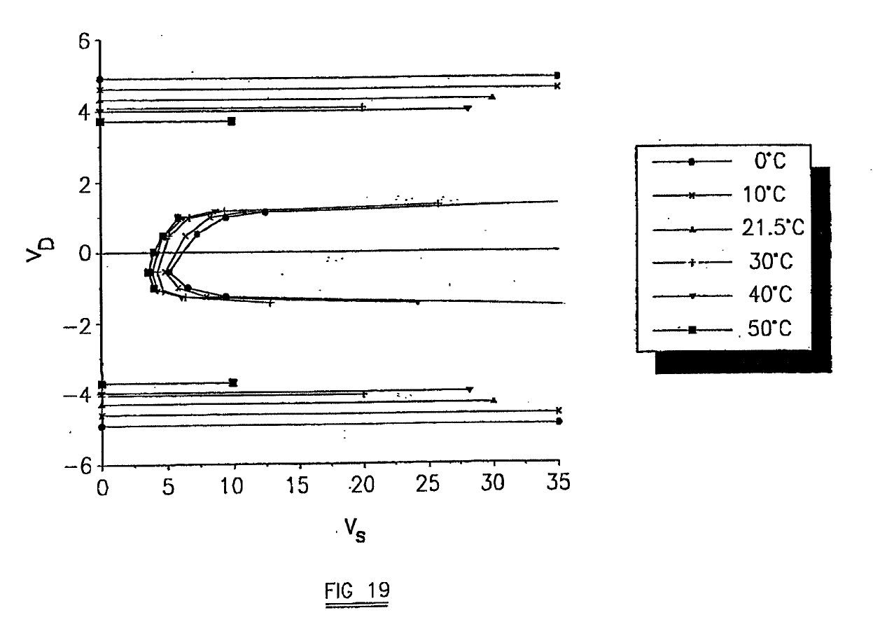

FIG. 19 shows the results of addressing the same liquid crystal layer as used for FIG. 18, using an embodiment in which there is no zero-voltage waveform between the blanking voltage waveform and the select voltage waveform. That is, the results of FIG. 19 were obtained using voltage waveforms of the type shown in FIGS. 5(a) and 5(b), but with the duration of the zero-voltage waveform P3 set to zero. Apart from setting the duration of the zero-voltage waveform P3 to zero, the results of FIG. 19 were obtained using voltage waveforms identical to those used to obtain the results of FIG. 18.

It will be seen that the switching characteristic shown in FIG. 19 show significantly less dependence on temperature than do the results of FIG. 18. This means that less temperature compensation of the select voltage waveform is required to compensate for the temperature-induced changes in the switching characteristics.

In the embodiments described above, in which a reset voltage waveform is applied, the reset voltage waveforms tend to be very large—that is, either to be very long, or to be of very high voltage. This is because the reset voltage waveform is intended to eliminate all undesired states from the liquid crystal layer in the first frame period, as is required when addressing a storage type display. In some applications, however, it is possible to spread the elimination of an undesired states over several frames, by applying a shorter and/or lower reset voltage waveform over a number of frames. This can be done, for example, when the display is being used to display video rate images. For example, a reset voltage waveform having a magnitude of 20V and a duration of 1 ms could be applied in several consecutive fares, instead of applying a single voltage waveform having a magnitude 15V and a duration of 50 ms in the first frame only.

The retention time of a display can be further improved by the use of a suitable isolation technique, for example such as that disclosed in UK Patent Application No. 9911730.1 and corresponding Korean application KR-10-200-27279. This application teaches essentially that first and second addressable areas of a liquid crystal display, such as first and second pixels, should be separated from one another by an isolation region. A liquid crystal state which is not one of the operating states is the stable state in the isolation region. The presence of the isolation region prevents the liquid crystal state in one of the addressable areas from growing into the other of the addressable areas.

The combination of providing a display device with such isolation regions and using an addressing method as described above, provides a long image retention time even in the absence of any applied voltage across the liquid crystal layer. The power consumption of the device thus becomes very low. Each addressing method described above can be applied to a LCD provided with an isolation region between adjacent addressable areas.

It is also preferable to provide the liquid crystal display with a nucleation mechanism of the general type described in co-pending UK Patent Application No. 9822762.2. Such a mechanism would ensure that the desired operating states were nucleated in the liquid crystal layer when a suitable voltage was applied, and this would allow the high-voltage reset voltage waveform to be eliminated.

What is claimed is:

1. A method of operating a liquid crystal display device having a layer of liquid crystal material switchable between first and second liquid crystal states, the method comprising the steps of: (a) applying a first voltage waveform across an addressable area of the liquid crystal layer of the display device to put the addressable area of the liquid crystal layer into the one of the first and second liquid crystal states having the higher energy when no electric field is applied across the liquid crystal layer; and (b) putting the addressable area of the liquid crystal layer into a desired one of the first and second liquid crystal states to obtain a desired display state.

2. A method as claimed in claim 1 wherein step (b) comprises applying a second voltage waveform across the addressable area of the liquid crystal layer to put the addressable area of the liquid crystal layer into the one of the first and second liquid crystal states having a lower energy when no electric field is applied across the liquid crystal layer.

3. A method as claimed in claim 1 and comprising the further step of (c) applying a first zero voltage waveform across the addressable area of the liquid crystal layer, step (c) being carried out after step (a) and before step (b).

4. A method as claimed in claim 1 and further comprising the step of (d) applying a reset voltage waveform across the addressable area of the liquid crystal layer to put the addressable area of the liquid crystal layer into the first or second liquid crystal state, step (d) being carried out before step (a).

5. A method as claimed in claim 4 and further comprising the step of (e) applying a second zero voltage waveform across the addressable area of the liquid crystal layer, step (e) being carried out after step (d) and before step (a).

6. A method as claimed in claim 4 and comprising the steps of: in a first frame, applying the reset voltage waveform to the addressable area of the liquid crystal layer, applying the first voltage waveform to the addressable area of the liquid crystal layer, and putting the addressable area into a desired one of the first and second liquid crystal states to obtain a desired display state for the first frame; and, in a second frame applying the first voltage waveform to the addressable area of the liquid a crystal layer and putting the addressable area into a desired one of the first and second liquid crystal states to obtain a desired display state for the second frame, but not comprising the step of applying the reset voltage waveform in the second frame.

7. A method as claimed in claim 4 and comprising the steps of in a first frame, applying a first reset voltage waveform to the addressable area of the liquid crystal layer, applying the first voltage waveform to the addressable area of the liquid crystal layer, and putting the addressable area into a desired one of the first and second liquid crystal states to obtain a desired display state for the first frame; and, in a second frame applying a second reset waveform-to the addressable area of the liquid crystal layer, applying the first voltage waveform to the addressable area of the liquid crystal layer, and putting the addressable area into a desired one of the first and second liquid crystal states to obtain a desired display state for the second frame; wherein the time integral of the magnitude of the second reset voltage waveform is smaller than the time integral of the magnitude of the first reset voltage waveform.

8. A method as claimed in claim 7 wherein the duration of the second reset voltage waveform is substantially equal to the duration of the first reset voltage waveform, and the magnitude of the second reset voltage waveform is less than the magnitude of the first reset voltage waveform.

9. A method as claimed in claim 7 wherein the duration of the second reset voltage waveform is less than the duration of the first reset voltage waveform, and the magnitude of the second reset voltage waveform is substantially equal to the magnitude of the first reset voltage waveform.

10. A method as claimed in claim 1 and comprising the step of selecting the first voltage waveform based on the temperature of the liquid crystal layer.

11. A method as claimed in claim 10 and comprising the step of reducing the time integral of the magnitude of the first voltage waveform as the temperature of the liquid crystal layer increases.

12. A method as claimed in claim 10 and comprising the step of reducing the duration of the first voltage waveform as the temperature of the liquid crystal layer increases.

13. A method as claimed in claim 10 and comprising the step of reducing the magnitude of the first voltage waveform as the temperature of the liquid crystal layer increases.

14. A method as claimed in claims 2 and comprising the step of selecting the second voltage waveform based on the temperature of the liquid crystal layer.

15. A method as claimed in claim 14 and comprising the step of reducing the time integral of the magnitude of the second waveform as the temperature of the liquid crystal layer increases.

16. A method as claimed in claim 14 and comprising the step of reducing the duration of the second voltage waveform as the temperature of the liquid crystal layer increases.

17. A method as claimed in claim 14 and comprising the step of reducing the magnitude of the second voltage waveform as the temperature of the liquid crystal layer increases.

18. A method as claimed in claim 1 wherein step (b) is carried out substantially immediately after step (a).

19. A method as claimed in claim 1 and further comprising the step of, after putting the addressable area into a desired one of the first and second liquid crystal states to obtain a desired display state, applying a stabilising voltage waveform across the addressable area of the liquid crystal layer, the stabilising voltage waveform being selected to substantially equalise the energy of the first liquid crystal state and the energy of the second liquid crystal state.

20. A method as claimed in claim 1 and comprising the steps of: switching a first addressable area of the liquid crystal layer using a method as claimed in any of claims 1 to 18; switching a second addressable area of the liquid crystal layer using a method as claimed in any of claims 1 to 18; and applying A voltage waveform across the second addressable area of the liquid crystal layer so as to substantially equalise the switching characteristics of the first addressable area and the switching characteristics of the second addressable area.

21. A method as claimed in claim 1 wherein at least one of the voltage waveforms is a d.c. balanced voltage waveform.

22. A method as claimed in claim 1 wherein the first liquid crystal state is a twist state having a first twist angle and the second liquid crystal state is a twist state having a second twist angle different from the first twist angle.

23. A method as claimed in claim 22 wherein the second twist angle is higher than the first twist angle.

24. A method as claimed in claim 23 wherein the first twist angle is Φ−180° and the second twist angle is Φ+180°, where Φ is the angle between the alignment direction of a first substrate of the display device and the alignment direction-of a second substrate of the display device, the layer of liquid crystal material being disposed between the first substrate and the second substrate.

25. A method as claimed in claim 22 wherein the first twist angle is 0° and the second twist angle is 360°.

26. A method as claimed in claim 1 wherein the or each addressable area of the liquid crystal layer is a pixel.

27. A method as claimed in claim 1 wherein the liquid crystal layer in a layer of a bitable twisted nematic liquid crystal material.

28. A method as claimed in claim 27 wherein the ratio of the thickness of the liquid crystal layer to the pitch of the liquid crystal material is selected such that one of the first and second liquid crystal states is the lowest energy state of the liquid crystal layer when no electric field is applied across the liquid crystal layer.

29. A method as claimed in claim 28 wherein the ratio of the thickness of the liquid crystal layer to the pitch of the liquid crystal material is selected such that the lowest energy state of the liquid crystal layer when no electric field is applied across the liquid crystal layer is a liquid crystal twist state having a twist angle of (Φ+180°), where Φ is the angle between the alignment direction of a first substrate of the display device and the alignment direction of a second substrate of the display device.

30. A method as claimed in claim 29 wherein the ratio of the thickness d of the liquid crystal layer to the pitch p of the liquid crystal material is selected such that d/p>(Φ+90°)/360°.

31. A method as claimed in claim 28 wherein the ratio of the thickness of the liquid crystal layer to the pitch of the liquid crystal material is selected such that the lowest energy state of the liquid crystal layer when no electric field is applied across the liquid crystal layer is a liquid crystal twist state having a twist angle of substantially 360°.

32. A method as claimed in claim 31 wherein the ratio of the thickness d of the liquid crystal layer to the pitch p of the liquid crystal material is selected such that d/p>0.75.

33. A method as claimed in claim 28 wherein the ratio of the thickness of the liquid crystal layer to the pitch of the liquid crystal material is selected such that one of the first and second liquid crystal states is the lowest energy state of the liquid crystal layer under substantially all operating conditions of the liquid crystal display device.

34. A method as claimed in claim 33 wherein the ratio of the thickness of the liquid crystal layer to the pitch of the liquid crystal material is selected such that a liquid crystal twist state having a twist angle of (Φ+180°) is the lowest energy state of the liquid crystal layer under substantially all operating conditions of the liquid crystal display device.

35. A method as claimed in claim 33 wherein the ratio of the thickness of the liquid crystal layer to the pitch of the liquid crystal material is selected such that a liquid crystal twist state having a twist angle of 360° is the lowest energy state of the liquid crystal layer under substantially all operating conditions of the liquid crystal display device.

36. A method as claimed in claim 28 wherein the ratio of the thickness of the liquid crystal layer to the pitch of the liquid crystal material is at least 0.76.

37. A method of operating a liquid crystal display device substantially as described herein with reference to the accompanying Figures.

38. A liquid crystal display device comprising a layer of liquid crystal material disposed between a first substrate and a second substrate, the layer of liquid crystal material being switchable between first and second liquid crystal states; wherein the ratio of the thickness of the liquid crystal layer to the pitch of the liquid material is selected such that one of the first and second liquid crystal states is the lowest energy state of the liquid crystal layer when no electric field is applied across the liquid crystal layer.

39. A device as claimed in claim 38 wherein the ratio of the thickness of the liquid crystal layer to the pitch of the liquid crystal material is such that the lowest energy state of the liquid crystal layer when no electric field is applied across the liquid crystal layer is a liquid crystal twist state having a twist angle of (Φ+180°).

40. A device as claimed in claim 39 wherein the ratio of the thickness d of the liquid crystal layer to the pitch p of the liquid crystal material satisfies d/p>(Φ+90°)/360°.

41. A device as claimed in claim 38 wherein the ratio of the thickness of the liquid crystal layer to the pitch of the liquid crystal material is such that the lowest energy state of the liquid crystal layer when no electric field is applied across the liquid crystal layer is a liquid crystal twist state having a twist angle of substantially 360°.

42. A device as claimed in claim 41 wherein the ratio of the thickness d of the liquid crystal layer to the pitch p of the liquid crystal material satisfies d/p>0.75.

43. A device as claimed in claim 38 wherein the ratio of the thickness of the liquid crystal layer to the pitch of the liquid crystal material is selected such that one of the first and second liquid crystal states is the lowest energy state of the liquid crystal layer under substantially all operating conditions of the liquid crystal display device.

44. A device as claimed in claim 43 wherein the ratio of the thickness of the liquid crystal layer to the pitch of the liquid crystal material is selected such that a liquid crystal twist state having a twist angle of (Φ+180°) is the lowest energy state of the liquid crystal layer under substantially all operating conditions of the liquid crystal display device.

45. A device as claimed in claim 43 wherein the ratio of the thickness of the liquid crystal layer to the pitch of the liquid crystal material is selected such that a liquid crystal twist state having a twist angle of 360° is the lowest energy state of the liquid crystal layer under substantially all operating conditions of the liquid crystal display device.

46. A device as claimed in claim 38 wherein the ratio of the thickness d of the liquid crystal layer to the pitch p of the liquid crystal material is at least 0.76.

47. A device as claimed in claim 38 and comprising: first and second addressable liquid crystal regions, each of the addressable liquid crystal regions being switchable between the first liquid crystal state and the second liquid crystal state;.and an isolation region provided between the first addressable liquid crystal region and the second addressable liquid crystal region, the isolation region comprising a region in which a third liquid crystal state is stable.

48. A device as claimed in claim 38 wherein the liquid crystal layer comprises a layer of a biatable twisted nematic liquid crystal material.

49. A device as claimed in claim 38 and further comprising addressing means for applying a voltage across an addressable area of the layer of liquid crystal material, the addressing means being adapted, in a first frame, (a) to apply a reset voltage waveform to the addressable area of the liquid crystal layer, and (b) to put the addressable area into a desired one of the first and second liquid crystal states to obtain a desired display state for the first frame; and the addressing means being adapted, in a second frame, (c) to put the addressable area into a desired one of the first and second liquid crystal states to obtain a desired display state for the second frame; the addressing means being adapted not to apply a reset voltage waveform in the second frame.

50. A device as claimed in claim 38 and further comprising addressing means for applying a voltage across an addressable area of the layer of liquid crystal material, the addressing means being adapted, in a first frame, (a) to apply a first reset voltage waveform to the addressable area of the liquid crystal layer and (b) to put the addressable area into a desired one of the first and second liquid crystal states to obtain a desired display state for the first frame, and, in a second frame, (c) to apply a second reset voltage waveform to the addressable area of the liquid crystal layer and (d) to put the addressable area into a desired one of the first and second liquid crystal states to obtain a desired display state for the second frame; the addressing means being adapted to apply the first and second reset voltages such that the time integral of the magnitude of the second reset voltage waveform is smaller than the time integral of the magnitude of the first reset voltage waveform.

51. A liquid crystal display device comprising: a layer of liquid crystal material switchable between first and second liquid crystal states; and addressing means for applying a voltage across an addressable area of the layer of liquid crystal material;
wherein the addressing means is adapted (a) to apply a first voltage waveform across the addressable area of the liquid crystal layer of the display device to put the addressable area of the liquid crystal layer into the one of the first and second liquid crystal states having the higher energy when no electric field is applied across the liquid crystal layer; and (b) to put the addressable area of the liquid crystal layer into a desired one of the first and second liquid crystal states to obtain a desired display state.
